(19) United States
(12) Patent Application Publication
(10) Pub. No.: US 2024/0157975 A1
(43) Pub. Date: May 16, 2024

(54) AUTONOMOUS DRIVING INTEGRATED CONTROL SYSTEM

(71) Applicant: Mitsubishi Electric Corporation, Tokyo (JP)

(72) Inventors: Michitoshi AZUMA, Tokyo (JP); Kohei MORI, Tokyo (JP); Toru HIGUCHI, Tokyo (JP); Hiroshi YAMADA, Tokyo (JP)

(73) Assignee: Mitsubishi Electric Corporation, Tokyo (JP)

(21) Appl. No.: 18/456,857

(22) Filed: Aug. 28, 2023

(30) Foreign Application Priority Data
Nov. 11, 2022 (JP) 2022-180895

(51) Int. Cl. B60W 60/00; B60W 30/09; B60W 30/095

(52) U.S. Cl. CPC B60W 60/00186; B60W 30/09; B60W 30/0956; B60W 2554/20; B60W 2554/80; B60W 2556/45

(57) ABSTRACT

An autonomous driving integrated control system includes multiple roadside monitoring devices and an autonomous driving device, wherein the multiple roadside monitoring devices each have a sensor and a transmitter that transmits information of a detected object, and wherein the autonomous driving device has: a receiver unit; a vehicle abnormal state detection unit; an escape route generation unit that generates, per each of the roadside monitoring devices, intersection escape routes for escaping from the intersection; a selection unit that compares the thus-generated intersection escape routes with each other in terms of their collision-avoidance levels, to thereby make selections; a travelable distance calculation unit that calculates an abnormal-time travelable distance; a vehicle control unit that, when an abnormal state of the vehicle is detected, causes the vehicle to travel along a high-level intersection escape route corresponding to the abnormal-time travelable distance; and a vehicle operation unit.

### TECHNICAL FIELD

The present disclosure relates to an autonomous driving integrated control system.

### BACKGROUND ART

Recently, it is desired to apply autonomous driving to transport vehicles. With the introduction of autonomous driving, it is expected that various social problems will be solved, for example, lack of drivers in logistics field will be improved, traffic jam will be improved, and the “last one mile problem” can be dealt with.

With respect to vehicles running within specific areas of a factory and the like, heretofore, the driver carries out transport using a truck or a tow carriage. In order to increase the operation rate of the factory, however, it is desired that the in-factory transport is operated full-time. According to such a method of increasing the number of towable vehicles or extending hours of transport working, it is required to increase machinery cost and cost for securing drivers, resulting in a large burden on the business operator. Thus, it is desired to apply autonomous driving even to such transport vehicles running within specific areas.

Society of Automotive Engineers (SAE) defines technical levels of autonomous driving for ordinary vehicles traveling on public roads. Many manufacturers and social organizations employ these technical levels. At Level 4 autonomous driving, conditions for continuing autonomous travel of a vehicle without the need of constant monitoring of the vehicle by the driver, are determined.

According to “Safety Technical Guidelines for Self-Driving Vehicles” set by Ministry of Land, Infrastructure, Transport and Tourism (Japan), the Level 4 autonomous driving is obligated to have the function of Minimum Risk Maneuver (MRM). The function of MRM is a function of autonomously causing a vehicle to stop safely when an autonomous driving system determines that autonomous driving is difficult to continue, as represented by the case where the vehicle gets out of Operation Design Domain (ODD), a failure occurs in the autonomous driving vehicle, or the like.

When an abnormality occurs in the autonomous driving vehicle entering an intersection, more risk may be assumed than when the vehicle is during travel on an ordinary road. This is because, if the vehicle makes a stop inside the intersection, the vehicle will hinder traffic and is also deemed to have likelihood of causing a collision. Accordingly, if an abnormality occurs in the autonomous driving vehicle entering an intersection, it is desired to cause the vehicle to prioritize escape from the intersection. Further, as a route for escaping from the intersection, it is desired to select such an escape route having a high collision-avoidance level by comparing multiple escape routes with each other in terms of their collision-avoidance levels.

A technique is disclosed in which, with respect to traveling of an autonomous driving vehicle at an intersection, an autonomous driving device of the vehicle and a roadside monitoring device are configured to share information, and when such a situation is assumed where the risk of colliding with or getting closed to an obstacle, etc. is high, a route for autonomous driving of the vehicle is subject to override control (forced operation) from the outside of the vehicle, to thereby cause the vehicle to travel along a suitable traveling route (for example, Patent Document 1).

### CITATION LIST

### Patent Document

Patent Document 1: Japanese Patent Application Laid-open No. 2022-65804

According to the technique disclosed in Patent Document 1, information around a road is acquired by a recognition device provided in the vehicle and a monitoring device provided in an external monitoring system. The recognition device and the monitoring device are each assumed to be a camera for imaging conditions therearound, a radar for detecting obstacles therearound, or the like. Using these two devices, obstacles around the traveling road are detected. Then, the route for autonomous traveling is verified in terms of whether or not the vehicle collides with or gets close to the obstacle. When an abnormality of the vehicle is detected by an abnormality detection unit for detecting an abnormality of the vehicle, in order to prevent the vehicle from contacting the obstacles around the traveling road, a route for autonomous driving is specified from the outside of the vehicle and an acceleration/deceleration instruction is given to that vehicle.

However, in Patent Document 1, there is no description about the processing that causes, when an abnormality occurs in an autonomous driving vehicle entering an intersection, the vehicle to prioritize escape from the intersection. Further, there is no mention about the method of selecting an escape route by comparing multiple escape routes with each other in terms of their collision-avoidance levels. According to the technique described in Patent Document 1, when an abnormality occurs in the vehicle inside an intersection, such a situation is conceivable in which the vehicle is controlled in an override manner (forced operation) from the outside to thereby slow down and stop inside the intersection. The vehicle stopping inside the intersection results in disturbing the traffic flow of other vehicles and increasing the risk of collision with other vehicles.

### SUMMARY

This disclosure has been made to solve the problem as described above. An object thereof is to provide an autonomous driving integrated control system which, when an abnormality occurs in the autonomous driving vehicle entering an intersection, selects from intersection escape routes generated corresponding to the abnormal states of the vehicle, an escape route having a high collision-avoidance level, to thereby cause the vehicle to travel along the thus-selected escape route.

### Solution to Problem

An autonomous driving integrated control system according to this application comprises multiple roadside monitoring devices and an autonomous driving device,
said multiple roadside monitoring devices each having:
a sensor that detects a nearby object; and
a transmitter that transmits viewing angle information of the sensor and information of the object detected by the sensor; and
said autonomous driving device having:
a receiver unit that receives the viewing angle information and the information of the object from the transmitter of each of the roadside monitoring devices;
a vehicle abnormal state detection unit that detects an abnormal state of a vehicle;
an escape route generation unit that generates, per each of the roadside monitoring devices and per each of multiple abnormal-time travelable distances, an intersection escape route for escaping from an intersection at an occurrence of abnormality in the vehicle entering the intersection, on a basis of the sets of information received from the roadside monitoring devices;
a selection unit that compares the respective intersection escape routes generated by the escape route generation unit, with each other in terms of their collision-avoidance levels each indicating a likelihood that the vehicle during travel on the intersection escape route will avoid a collision with the object, to thereby select, per each of the abnormal-time travelable distances, the intersection escape route having a highest collision-avoidance level as a high-level intersection escape route;
a travelable distance calculation unit that, when the abnormal state of the vehicle is detected by the vehicle abnormal state detection unit, calculates an abnormal-time travelable distance corresponding to one of said abnormal-time travelable distances and suited to the abnormal state;
a vehicle control unit that, when the abnormal state of the vehicle entering the intersection is detected by the vehicle abnormal state detection unit, outputs a command signal for causing the vehicle to travel along, among the high-level intersection escape routes selected by the selection unit, the high-level intersection escape route corresponding to the abnormal-time travelable distance calculated by the travelable distance calculation unit; and
a vehicle operation unit that activates an actuator by using the command signal outputted by the vehicle control unit.

### Advantageous Effects

By the autonomous driving integrated control system according to this disclosure, it is possible to generate the intersection escape routes corresponding to the abnormal states of the vehicle and, when an abnormality occurs in the autonomous driving vehicle entering an intersection, to select from these escape routes, an escape route having a high collision-avoidance level, to thereby cause the vehicle to travel along the thus-selected escape route. Accordingly, if an abnormality occurs in the autonomous driving vehicle entering an intersection, the vehicle is caused to prioritize escape from the intersection and thus, it is possible to prevent the vehicle from disturbing the traffic flow of other vehicles and from increasing the risk of collision with other vehicles.

### BRIEF DESCRIPTION OF DRAWINGS

FIG. 1 is a layout view of roadside monitoring devices according to Embodiment 1.

FIG. 2 is an entire configuration diagram of an autonomous driving integrated control system according to Embodiment 1.

FIG. 3 is a configuration diagram of a data collection device according to Embodiment 1.

FIG. 4 is a configuration diagram of an edge server according to Embodiment 1.

FIG. 5 is a configuration diagram of a driving device according to Embodiment 1.

FIG. 6 is a hardware configuration diagram of a control device according to Embodiment 1.

FIG. 7 is a table for illustrating a relationship between an object and a collision-avoidance level according to Embodiment 1.

FIG. 8 is a table for illustrating a relationship between a stop position and a collision-avoidance level addition score according to Embodiment 1.

FIG. 9 is a first table for illustrating a relationship between an abnormal state and a travelable distance according to Embodiment 1.

FIG. 10 is a second table for illustrating a relationship between an abnormal state and a travelable distance according to Embodiment 1.

FIG. 11 is a diagram for illustrating intersection escape routes according to Embodiment 1.

FIG. 12 is a flowchart showing processing by the edge server according to Embodiment 1.

FIG. 13 is a flowchart showing processing by the driving device according to Embodiment 1.

FIG. 14 is a flowchart showing calculation processing of the travelable distance by the driving device according to Embodiment 1.

FIG. 15 is an entire configuration diagram of an autonomous driving integrated control system according to Embodiment 2.

FIG. 16 is a configuration diagram of an edge server according to Embodiment 2.

FIG. 17 is a configuration diagram of a driving device according to Embodiment 2.

FIG. 18 is a first flowchart showing processing by the edge server according to Embodiment 2.

FIG. 19 is a second flowchart showing processing by the edge server according to Embodiment 2.

FIG. 20 is a first flowchart showing processing by the driving device according to Embodiment 2.

FIG. 21 is a second flowchart showing processing by the driving device according to Embodiment 2.

### DESCRIPTION OF EMBODIMENTS

### 1. Embodiment 1

<Layout of Roadside Monitoring Devices>

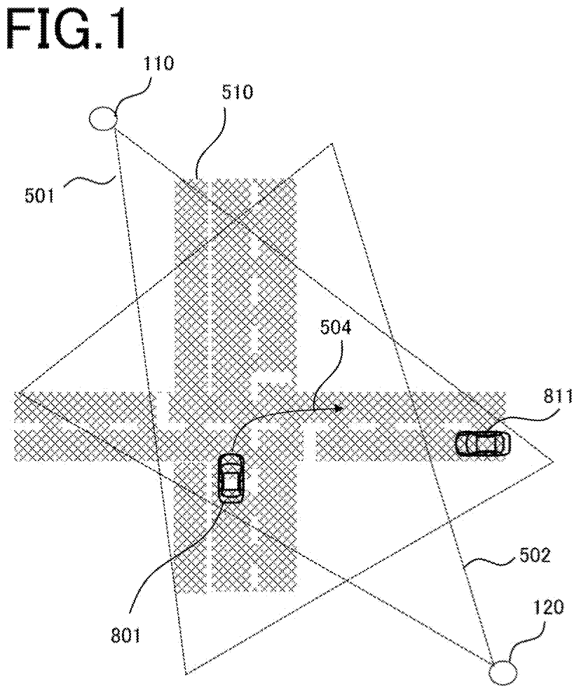

FIG. 1 is a layout view of roadside monitoring devices 110, 120 around an intersection according to Embodiment 1. The roadside monitoring device is referred to also as an RSU (Road Side Unit). FIG. 1 shows one exemplary intersection, and in which a vehicle 801 that enters the intersection and is going to turn right, and a vehicle 811 that is getting close to the intersection from the right side of the vehicle 801, are depicted. The roadside monitoring device 110 placed near the road has sensors that detect nearby objects, and a recognizable range of the sensors is represented by a viewing angle 501. Likewise, sensors of the roadside monitoring device 120 that detect nearby objects have a recognizable range represented by a viewing angle 502. The roadside monitoring devices 110, 120 can monitor not only the central area of the intersection but also an area around the intersection. The roadside monitoring devices 110, 120 are located so that the dead area around the intersection is minimized.

In FIG. 1, the roadside monitoring devices 110, 120 are located diagonally to each other so that their viewing fields extend toward the intersection, and each identify a position, a speed, a moving direction, a size, a shape and a type, etc. of a pedestrian, a four-wheel vehicle, a stationary obstacle and the like within the viewing field. Although two roadside monitoring devices 110, 120 are located in FIG. 1, three or more roadside monitoring devices may be placed around the intersection in order to increase the monitoring area and to ensure redundancy of the roadside monitoring devices.

On one side of the road that constitutes the intersection of FIG. 1, a stoppable area 510 where vehicles are allowed to stop is established. The stoppable area means a vehicle-stop permission section, such as a stopping lane, a time-limited parking zone or a roadside strip; or a section where vehicles are allowed to stop in an emergency, such as a stopping area in front of a bus stop, a road shoulder or the like. No-parking/stopping roadside strip or a pedestrian roadside strip that are defined according to the Road Traffic Law, may be excluded.

<Configuration of Autonomous Driving Integrated Control System>

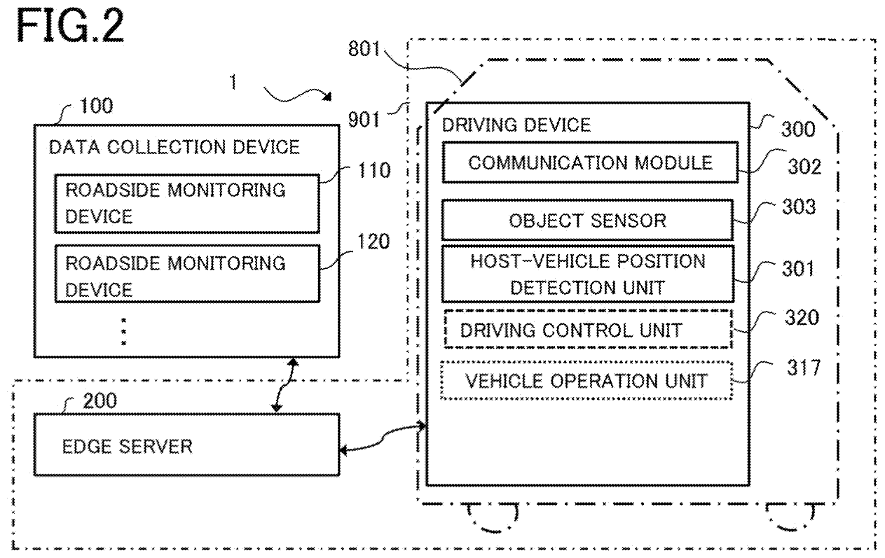

FIG. 2 is an entire configuration diagram of an autonomous driving integrated control system 1 according to Embodiment 1. The vehicle 801 for which the autonomous driving integrated control system 1 is employed, executes autonomous driving by use of a driving device 300 that communicates with an edge server 200 that has received information from the roadside monitoring devices 110, 120 placed outside the vehicle. As shown in FIG. 1, in the case of an intersection without traffic signals but with a temporary stop indication, the vehicle comes to a stop at a stop line in front of the intersection. When no abnormality occurs in the vehicle, on the basis of the information inputted from the edge server 200, the driving device 300 determines whether or not the vehicle can turn right at the intersection, and then the vehicle starts to turn right.

The driving device 300 has confirmed beforehand that the vehicle will not collide with another object during turning to the right and thus, the vehicle is judged not to collide with the oncoming vehicle 811 during the right turn movement. Whether or not the right turn movement is allowed is judged at a time at which the vehicle runs over the stop line (or a virtual intersection entrance line if there is no stop line), and after running over the stop line (or the virtual intersection entrance line), the vehicle 801 travels autonomously along a target route for passing through the intersection.

The autonomous driving integrated control system 1 is configured with: a data collection device 100 having multiple roadside monitoring devices such as the roadside monitoring devices 110, 120; the edge server 200; and the driving device 300 installed in the vehicle 801. Autonomous driving of the vehicle 801 can be achieved not only by recognizing its external environment by use of an object sensor 303 included in the driving device 300 installed in the vehicle 801 but also by recognizing an environment around the road and the intersection by use of sensors that the roadside monitoring devices 110, 120 have. The edge server 200 and the driving device 300 constitute an autonomous driving device 901 that is provided with the data collection device 100 as its external device.

<Data Collection Device and Roadside Monitoring Device>

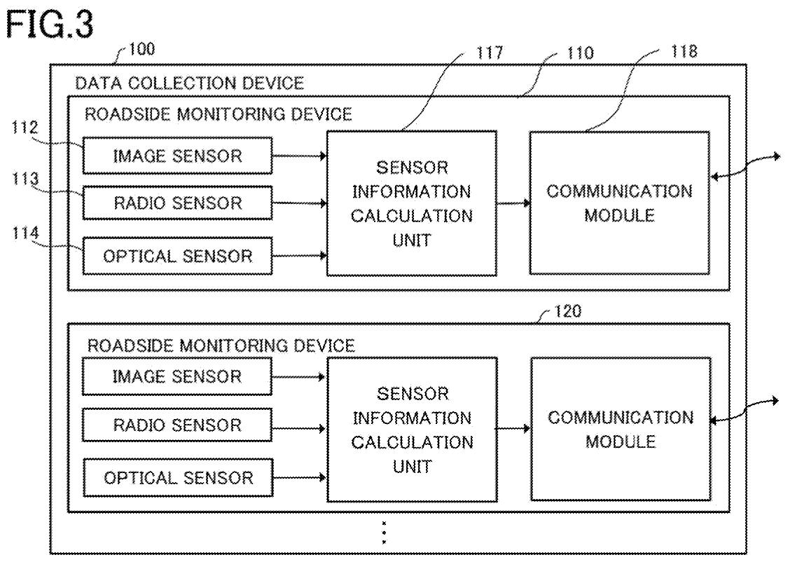

FIG. 3 is a configuration diagram of the data collection device 100 according to Embodiment 1. The data collection device 100 is configured with multiple roadside monitoring devices including the roadside monitoring devices 110, 120. The multiple roadside monitoring devices may be located collectively at the same place so as to perform monitoring in all directions around them in a shared manner. Instead, as shown in FIG. 1, the multiple roadside monitoring devices may be located apart from each other so as to monitor the intersection from different directions.

In the following, although description will be made about the roadside monitoring device 110, the same applies to the roadside monitoring device 120, etc. The roadside monitoring device 110 has sensors that recognize an external environment within the specified viewing angle 501 to thereby detect objects around the intersection and the road. As the objects to be detected, a four-wheel vehicle, a two-wheel vehicle, a pedestrian, an animal and another moving object, and a fallen object, a sign and another stationary object, etc. may be assumed. An image sensor 112, a radio sensor 113 and an optical sensor 114 are included as the sensors that recognize the external environment.

As represented by a monitoring camera, the image sensor 112 images an object and then calculates from the image data captured within the specified viewing angle, a distance to that object. From the image data, a size, a moving direction, a moving speed, an attribution or the like of the object may be acquired. As the image sensor 112, a visible light camera, an infrared camera or the like may be used.

As the radio sensor 113, a millimeter wave radiometer radar (MMWR) that uses a frequency range of 24 to 79 GHz, or the like may be used. By the radio sensor 113, it is possible to detect the position of the object and also to detect, using a Doppler effect, the moving speed of the object.

As the optical sensor 114, a laser radar, a LiDAR (Light Detection and Ranging) or the like may be used. It is possible to recognize the position and the shape of the object by radiating laser light within a fixed viewing field to thereby detect point-group data obtained due to reflection of the laser light on the object.

A sensor information calculation unit 117 receives information of the image sensor 112, the radio sensor 113 and the optical sensor 114 as sensors that recognize the external environment. In the sensor information calculation unit 117, a sensor fusion technique in which an object is detected using these pieces of information in combination may be employed. By combining such plural types of sensor information, it becomes possible to remove noise information to thereby perform ranging, speed detection and attributive identification of an object highly reliably. Further, an obstacle may be identified on the basis of a reinforcement learning such as deep learning.

These pieces of information may be all processed by the sensor information calculation unit 117; however, information processing may be executed in each of these sensors in such a manner that the data acquired by such various sensors is processed there so that only information of a position, an outer shape, a speed and an attribution about the identified object, is transferred to the sensor information calculation unit 117. This makes it possible to execute processing of the sensor information in a distributed manner, so that an amount of information to be processed solely by the sensor information calculation unit 117 can be reduced.

Further, although the roadside monitoring device 110 may use all of the image sensor 112, the radio sensor 113 and the optical sensor 114, it may use only a part of these sensors. Further, in order to recognize the external environment, another sensor such as an ultrasonic sensor or the like may be used. In addition, another sensor that provides as its sensor information, information related to a traffic flow or a weather condition may be used in combination.

Using the sensor information calculation unit 117, the roadside monitoring device 110 also performs monitoring of an abnormal state of each of the sensors. When a failure, a power abnormality or the like occurs in the image sensor 112, the radio sensor 113 and the optical sensor 114, it is detected by the sensor information calculation unit 117.

Based on the information received from the various sensors, the sensor information calculation unit 117 transfers object information such as a position, a speed, an outer shape, an attribution, etc. of the object, and the viewing angle information of the sensors, to the edge server 200 through a communication module 118. Further, the sensor information calculation unit 117 also transmits information related to an abnormal state of the sensor to the edge server 200 through the communication module 118.

<Edge Server>

In accordance with the current advancement of communication technology and processing technology as represented by 5G and an LTE (Long Term Evolution), such techniques of Mobile Edge Computing (MEC) and Multi Access Edge Computing (MAEC) in which information is not processed by a terminal itself but is processed by a server that is placed outside and near the terminal, are beginning to be utilized. With respect to the practice of an autonomous driving vehicle, heretofore, it has been proposed to recognize an environment around the vehicle in a manner relying on information of the sensors provided in the vehicle, and to receive processing support by use of a large-scale remote server on a cloud. However, it is now being realized that a large amount of information is processed by use of an edge server provided at a place near the vehicle, to thereby promptly share information with the vehicle. Note that the edge server may be equipped in each of the terminals itself in a distributed manner.

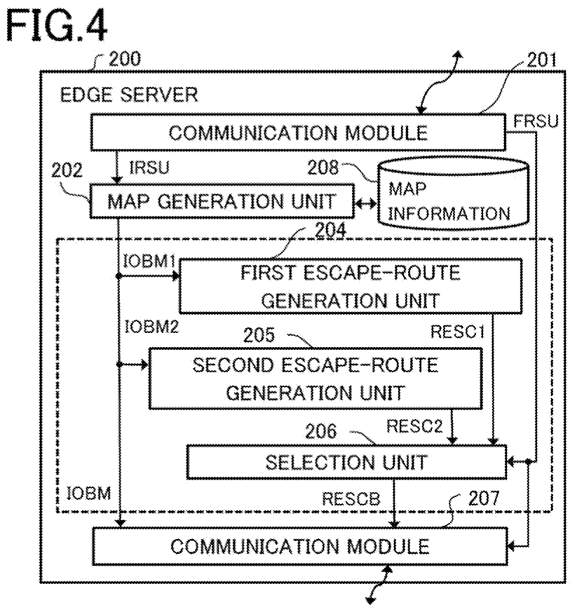

FIG. 4 is a configuration diagram of the edge server 200 according to Embodiment 1. The edge server 200 establishes high-speed communications with the data collection device 100 and the roadside monitoring devices 110, 120, etc. that constitute the data collection device 100, through a communication module 201, to thereby share the information. The edge server 200 is a server that is provided at a place near the terminal (in this case, the driving device 300 installed in the vehicle 801) and that is used to achieve a low delay, and may be provided at each of intersections.

The communication module 201 of the edge server 200 receives, as roadside monitored information IRSU, the object information and the viewing angle information of the sensors, from each of the roadside monitoring devices, and then transfers the roadside monitored information to a map generation unit 202. Further, the communication module 201 receives the information related to an abnormal state of the sensor from each of the roadside monitoring devices, and then transfers this information together with information about an abnormality in communication (communication disruption or the like) with the roadside monitoring device, as abnormality information FRSU, to a selection unit 206 and a communication module 207. The communication module 207 is a module for establishing communications with a communication module 302 of the driving device 300 installed in the vehicle 801. The communication module 201 and the communication module 207 may be combined into a single module.

The map generation unit 202 of the edge server 200 superimposes the roadside monitored information IRSU of all of the roadside monitoring devices, on map information 208 to thereby generate binding map information IOBM. Further, the map generation unit 202 transfers first binding map information IOBM1 resulting from superimposing the roadside monitored information according to the roadside monitoring device 110 on the map information 208, to a first escape-route generation unit 204. On the basis of the first binding map information IOBM1 and the position information of the vehicle 801, the first escape-route generation unit 204 generates multiple escape routes from the intersection for respective ones of abnormal-time travelable distances. The first escape-route generation unit 204 transfers such first escape routes (RESC1) based on the roadside monitored information according to the roadside monitoring device 110, to the selection unit 206. Here, the escape routes from the intersection shall be generated within the viewing angle 501 of the sensors in the roadside monitoring device 110, so that any route departing from the viewing angle 501 of the sensors is excluded.

The map generation unit 202 transfers second binding map information IOBM2 resulting from superimposing the roadside monitored information according to the roadside monitoring device 120 on the map information 208, to a second escape-route generation unit 205. On the basis of the second binding map information IOBM2 and the position information of the vehicle 801, the second escape-route generation unit 205 generates multiple escape routes from the intersection for respective ones of abnormal-time travelable distances. The second escape-route generation unit 205 transfers such second escape routes (RESC2) based on the roadside monitored information according to the roadside monitoring device 120, to the selection unit 206. Here, the escape routes from the intersection shall be generated within the viewing angle 502 of the sensors in the roadside monitoring device 120, so that any route departing from the viewing angle 502 of the sensors is excluded.

In the selection unit 206 of the edge server 200, the intersection escape routes generated, for respective ones of the roadside monitoring devices and respective ones of the abnormal-time travelable distances, by the first escape-route generation unit 204 and the second escape-route generation unit 205, are compared with each other in term of their collision-avoidance levels each indicating a likelihood that the vehicle during traveling on the intersection escape route will avoid a collision with an object, to thereby select the intersection escape route having a highest collision-avoidance level as a high-level intersection escape route RESCB, per each of the abnormal-time travelable distances. In FIG. 4, the intersection escape routes generated on the basis of the roadside monitored information according to two roadside monitoring devices 110, 120, are compared for selection; however, the number of intersection escape routes to be compared increases as the number of the roadside monitoring devices increases.

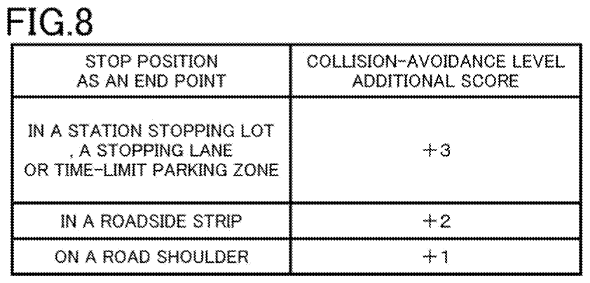

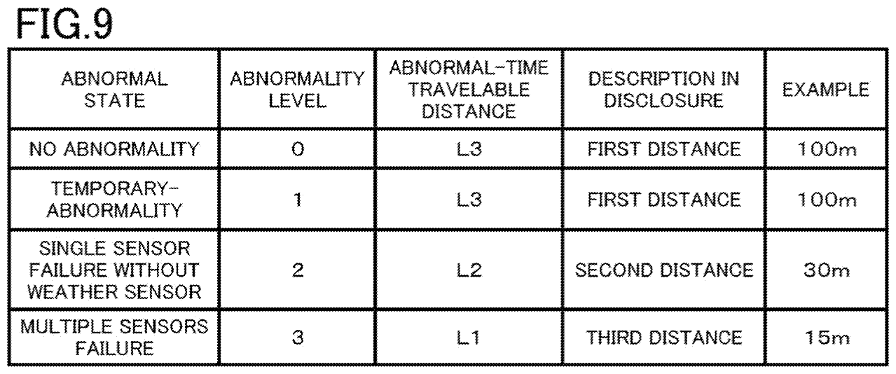

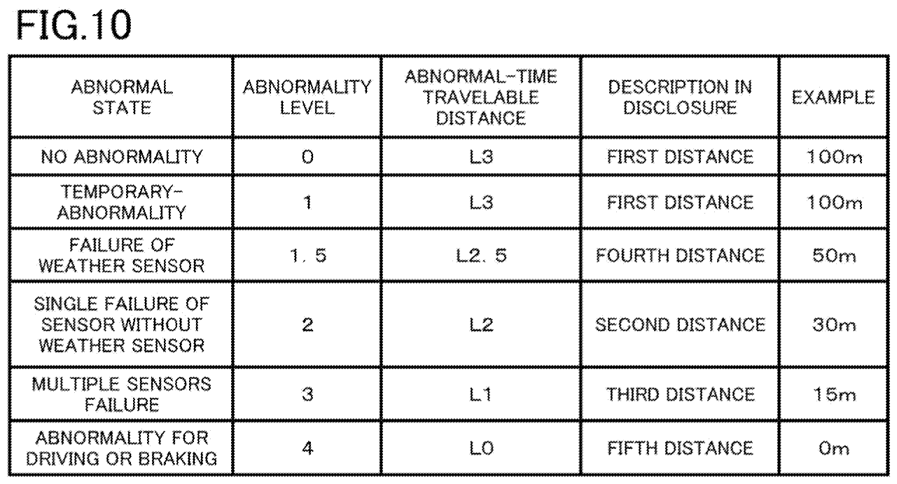

Details of the abnormal-time travelable distance and the collision-avoidance level will be described later using FIG. 7 to FIG. 10. In FIG. 7, the collision-avoidance levels are separately set into four stages, and in FIG. 8, a score to be added to the collision-avoidance level is set to from +1 to +3. In FIGS. 9 and 10, as the abnormal-time travelable distances, three types of distances and four types of distances are specified, respectively, depending on a vehicle abnormal state. In the edge server 200, intersection escape routes for respective ones of multiple types of distances are generated beforehand. When intersection escape routes are thus generated beforehand and stored in a selected manner, it is possible to promptly employ the intersection escape route when an abnormality occurs in the vehicle.

The high-level intersection escape routes RESCB selected for the respective ones of the multiple abnormal-time travelable distances, are transferred by the selection unit 206 to the driving device 300 through the communication module 207. On this occasion, the abnormality information FRSU related to each of the roadside monitoring devices is also transferred to the driving device 300 through the communication module 207.

The edge server 200 retains, per each of the roadside monitoring devices, the binding map information resulting from superimposing the roadside monitored information received from the roadside monitoring device, on the map information, and generates the escape routes per each of the roadside monitoring devices. Thus, if an abnormality occurs in the individual roadside monitoring devices, it is possible to promptly eliminate an influence of the abnormal roadside monitoring device. Then, from among the escape routes based on the roadside monitored information of the non-abnormal roadside monitoring devices, it is possible to select the intersection escape route RESCB having a highest collision-avoidance level, per each of the abnormal-time travelable distances.

The description has been made assuming that the edge server 200 retains, per each of the roadside monitoring devices, the binding map information resulting from superimposing the roadside monitored information received from the roadside monitoring device, on the map information. However, if there are a large number of roadside monitoring devices, it is allowed to form groups of multiple roadside monitoring devices and to prepare and retain the binding map information per each of the groups of the roadside monitoring devices.

In terms of information processing speed and capacity, the edge server 200 is not as restricted as the driving device 300 that is an in-vehicle device. The edge server 200 can generate many intersection escape routes and compare them for selection, while processing a large amount of information, on the basis of the roadside monitored information received from the multiple roadside monitoring devices. This makes it possible to select more suitable intersection escape routes while reducing the burden of the driving device 300 installed in the vehicle 801.

<Driving Device>

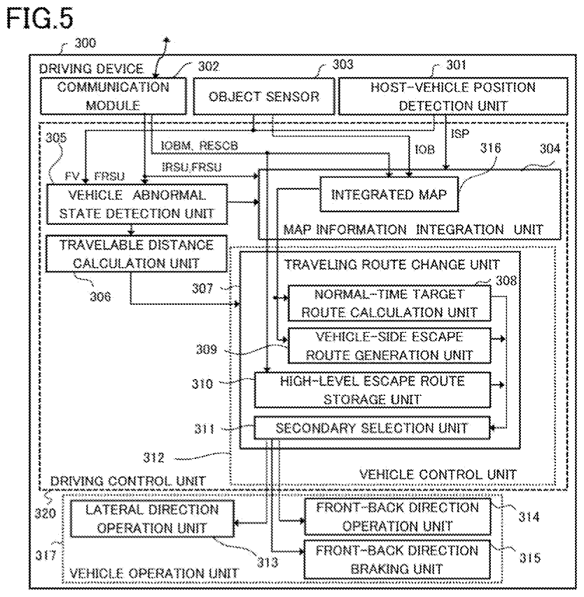

FIG. 5 is a configuration diagram of the driving device 300 according to Embodiment 1. In the driving device 300 installed in the vehicle 801, a host-vehicle position detection unit 301 that determines the position of the vehicle, a communication module 302 that transmits/receives information to/from the edge server 200, and the object sensor 303 that detects a position, a speed and a type of an object around the vehicle, are provided.

A driving control device 320 that uses, as its inputs, signals from the host-vehicle position detection unit 301, the communication module 302 and the object sensor 303, activates a lateral direction operation unit 313, a front-back direction operation unit 314 and a front-back direction braking unit 315, by means of a vehicle control unit 312. This causes the vehicle 801 to travel autonomously. The lateral direction operation unit 313, the front-back direction operation unit 314 and the front-back direction braking unit 315 are referred to collectively as a vehicle operation unit 317.

The host-vehicle position detection unit 301 can calculate a host vehicle position by using: positioning information from a GNSS (Global Navigation Satellite System) that detects the host vehicle position; a travel distance sensor that detects the wheel rotation number of the vehicle 801; a gyro sensor that detects the acceleration, speed, angular acceleration and angular speed of the vehicle 801; and the like. It is noted that the accuracy of the host vehicle position detected by the travel distance sensor may be affected also by the air pressure of the tire. Thus, the vehicle 801 may be provided with a tire air pressure sensor. The object sensor 303 may be a sensor that is the same as one of the image sensor 112, the radio sensor 113, the optical sensor 114 and the like included in the roadside monitoring device 110, or may be a combined one of all of them.

Using a vehicle abnormal state detection unit 305, the driving control unit 320 detects an abnormality of the object sensor 303, the host-vehicle position detection unit 301 or the like. Further, the driving control unit 320 can detect an abnormality of the communication module 302, and can also detect an abnormal state of the roadside monitoring device 110, 120 through communication with the edge server 200 by way of the communication module 302.

The driving control unit 320 includes a map information integration unit 304. The map information integration unit 304 receives host-vehicle position information IS outputted from the host-vehicle position detection unit 301, and object sensor information IO outputted by the object sensor 303. In addition, the map information integration unit 304 receives the binding map information IOBM that the communication module 302 has received from the edge server 200, and the high-level intersection escape routes RESCB for the respective ones of the multiple types of abnormal-time travelable distances.

The map information integration unit 304 uses, as its inputs, these sets of information and integrates the information of the objects detected by the data collection device 100 and the driving device 300, to thereby update an integrated map 316. The map information integration unit 304 transfers the thus-updated integrated map 316 to a traveling route change unit 307.

<Normal-Time Target Route Calculation Unit>

On the basis of the updated integrated map 316, a normal-time target route calculation unit 308 in the traveling route change unit 307 calculates a normal-time target route. Since the vehicle 801 is already planned to turn right at the intersection, the target route that will not cause a collision with an obstacle is generated on the basis of the integrated map 316, and is transferred to a secondary selection unit 311.

When the normal-time target route calculated by the normal-time target route calculation unit 308 is confirmed to be proper, the secondary selection unit 311 selects the normal-time target route as a target route for use. Here, the target route may be represented by vectors including a parameter of any one of the host-vehicle position, the host-vehicle speed, the host-vehicle acceleration, the host-vehicle jerk, etc. In order to cause the vehicle 801 to travel along the target route, based on a movement model of that vehicle, a lateral direction operation target amount, a front-back direction operation target amount and a front-back direction braking target amount are calculated. Then, respective operation command signals are outputted from the vehicle control unit 312 to the lateral direction operation unit 313, the front-back direction operation unit 314 and the front-back direction braking unit 315 of the vehicle operation unit 317.

As the lateral direction operation target amount, the vehicle control unit 312 may specify a target steering angle, a target steering angular speed, a target steering torque or the like, to thereby perform feedback control, feedforward control or combination control thereof so as to track the operation target amount. The lateral direction operation unit 313 operates according to the operation target amount outputted from the vehicle control unit 312. As the lateral direction operation unit 313, an electric power steering device with a steering angle sensor, and an electric power steering controller that controls the rotation of the electric power steering device, are included in the vehicle. This makes it possible to achieve a configuration that performs tracking control toward the target steering angle, the target steering angular speed or a differential value thereof.

As the front-back direction operation target amount, the vehicle control unit 312 may specify a target vehicle speed, a target acceleration, a target jerk or a target driving torque or the like, to thereby perform feedback control, feedforward control or combination control thereof so as to track the operation target amount. The front-back direction operation unit 314 operates according to the front-back direction operation target amount outputted from the vehicle control unit 312. As the front-back direction operation unit 314, an electric motor for driving provided with a rotation sensor, and an inverter that controls the rotation of the electric motor for driving, are included in the driving device 300. This makes it possible to achieve a configuration that performs tracking control toward the target longitudinal distance, the target vehicle speed or a differential value thereof.

As the front-back direction braking target amount, the vehicle control unit 312 may specify a brake pressure, to thereby perform feedback control, feedforward control or combination control thereof so as to track the braking target amount. The front-back direction braking unit 315 operates according to the front-back direction braking target amount outputted from the vehicle control unit 312. As the front-back direction braking unit 315, a hydraulic brake and a control unit that controls the pressure of the hydraulic brake are included in the vehicle. This makes it possible to achieve a configuration that controls the brake pressure so that the deceleration of the vehicle tracks the target deceleration.

<Vehicle-Side Escape Route Generation Unit>

The driving device 300, even if its communication with the roadside monitoring device 110, 120 or the edge server 200 is interrupted, prioritizes escape from the intersection when a vehicle abnormal state is detected. For that purpose, a vehicle-side escape route generation unit 309 in the traveling route change unit 307 generates an intersection escape route on the basis of the integrated map 316.

On this occasion, in order to prevent too much increase in the load of the driving device, only the escape route corresponding to an abnormality level 3 and an abnormal-time travelable distance L1 (15 m) may be generated. Since the distance for travel is short, calculation of the escape route can be executed promptly, and the intersection escape route can be generated not through communication with the edge server. Further, it is allowed to set a predetermined vehicle-side-escape-route generation distance and to generate the intersection escape route with respect to the vehicle-side-escape-route generation distance.

<High-Level Escape Route Storage Unit>

The traveling route change unit 307 stores in a high-level escape route storage unit 310, the high-level intersection escape routes RESCB transmitted from the edge server 200. Then, route selection is made by the secondary selection unit 311 on the basis of the vehicle abnormal state detected by the vehicle abnormal state detection unit 305, and the abnormal-time travelable distance corresponding to the vehicle abnormal state. When there is no abnormality of the vehicle, the normal-time target route is selected. When the abnormality level is 3 and the abnormal-time travelable distance is L1 (15 m), the escape route generated by the vehicle-side escape route generation unit 309 is selected.

When the abnormality level is 1 or 2 and the abnormal-time travelable distance is L3, L2.5 or L2 (100 m, 50 m or 30 m), the high-level intersection escape route RESCB transmitted from the edge server 200 is selected. Since it suffices to employ the high-level intersection escape routes RESCB already generated and selected in the edge server 200, it is eliminated that the load of the driving device 300 becomes large. Further, since the abnormal-time travelable distances L3, L2.5 and L2 (100 m, 50 m and 30 m) are relatively long, there are provided a lot of generation patterns of the intersection escape routes. Thus, it is reasonable that the generation and selection of the high-level intersection escape routes is made by the edge server 200, also because this results in load dispersion.

As compared with the intersection escape routes calculated by the driving device 300, the traveling routes calculated by the edge server 200 spread wider. This makes it possible to set a target stop position at a more suitable point in the routes for escaping out the intersection. Further, another vehicle during travel along a target route can also be monitored by the roadside monitoring device. Thus, a benefit emerges that the vehicle 801 can be moved to a point that is much more suitable from the overall standpoint.

Even when the abnormality level is 3 and the abnormal-time travelable distance is L1 (15 m), the high-level intersection escape route RESCB already generated and selected by the edge server 200 may be employed. The escape route generated by the vehicle-side escape route generation unit 309 may be used only when the communication with the roadside monitoring devices 110, 120 or the edge server 200 is disabled. Further, it is allowed to set, separately from the abnormal-time travelable distance L1, the vehicle-side-escape-route generation distance, thereby to select the escape route generated by the vehicle-side escape route generation unit 309 when the abnormal-time travelable distance is equal to or shorter than the vehicle-side-escape-route generation distance, and to employ the high-level intersection escape route RESCB when the abnormal-time travelable distance is longer than the vehicle-side-escape-route generation distance. Since the vehicle-side escape route generation unit 309 in the traveling route change unit 307 executes generation of the escape route only when the distance for the escape route is so short, the load does not become too much large. Further, since a range for the high-level intersection escape route RESCB to be generated and selected by the edge serve 200 may be set arbitrarily, the load of the edge server 200 can be adjusted.

<Hardware Configuration of Control Device>

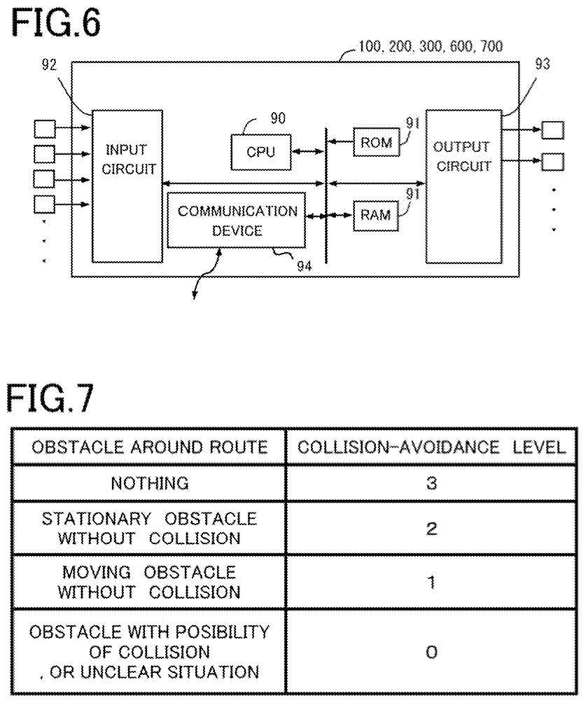

FIG. 6 is a hardware configuration diagram of a control device. The hardware configuration shown in FIG. 6 may be applied to the data collection device 100, the edge server 200 (or 600) and the driving device 300 (or 700). Further, it may be applied individually to the roadside monitoring devices 110, 120. Here, description will be made about a case where it is applied to the driving device 300 as a representative. In this Embodiment, the driving device 300 is an electronic control device which is installed in the vehicle 801 in order to cause the vehicle 801 to be driven autonomously. The respective functions of the driving device 300 are implemented by a processing circuit included in the driving device 300. Specifically, the driving device 300 includes as the processing circuit: an arithmetic processing device 90 (computer) such as a CPU (Central Processing Unit) or the like; storage devices 91 that perform data transactions with the arithmetic processing device 90; an input circuit 92 that inputs external signals to the arithmetic processing device 90; an output circuit 93 that externally outputs signals from the arithmetic processing device 90; and the like. The respective pieces of hardware, such as the arithmetic processing device 90, the storage devices 91, the input circuit 92, the output circuit 93, etc. are connected to each other by way of a wired network such as a bus, or a wireless network.

As the arithmetic processing device 90, there may be included an ASIC (Application Specific Integrated Circuit), an IC (Integrated Circuit), a DSP (Digital Signal Processor), a GPU (Graphics Processing Unit), an FPGA (Field Programmable Gate Array), any one of a variety of logic circuits, any one of a variety of signal processing circuits, or the like. Further, multiple arithmetic processing devices 90 of the same type or different types may be included so that the respective parts of processing are executed in a shared manner. As the storage devices 91, there are included a RAM (Random Access Memory) that is configured to allow reading and writing of data by the arithmetic processing device 90, a ROM (Read Only Memory) that is configured to allow reading of data by the arithmetic processing device 90, and the like. As the storage device 91, a non-volatile or volatile semiconductor memory, such as a flash memory, an SSD (Solid State Drive), an EPROM, an EEPROM or the like; a magnetic disc; a flexible disc; an optical disc; a compact disc; a mini disc; a DVD; or the like, may be used. The input circuit 92 includes A-D converters, a communication circuit, etc. to which a variety of sensors and switches and a communication line, are connected, and which serve to input the output signals of the sensors and switches, and communication information, to the arithmetic processing device 90. The output circuit 93 includes a driver circuit, a communication circuit, etc. which serve to output control signals coming from the arithmetic processing device 90. The interfaces of the input circuit 92 and the output circuit 93 may be those based on the specification of CAN (Control Area Network) (Registered Trademark), Ethernet (Registered Trademark), USB (Universal Serial Bus) (Registered Trademark), DVI (Digital Visual Interface) (Registered Trademark), HDMI (High-Definition Multimedia Interface) (Registered Trademark) or the like. Further, independently of the input circuit 92 and the output circuit 93, it is allowed to establish communication by directly connecting the arithmetic processing device 90 to a communication device 94.

The respective functions that the driving device 300 includes, are implemented in such a manner that the arithmetic processing device 90 executes software (programs) stored in the storage device 91 such as the ROM or the like, to thereby cooperate with the other hardware in the driving device 300, such as the other storage device 91, the input circuit 92, the output circuit 93, etc. Note that the set data of threshold values, determinative values, etc. to be used by the driving device 300 is stored, as a part of the software (programs), in the storage device 91 such as the ROM or the like. Although each of the functions that the driving device 300 has, may be established by a software module, it may be established by a combination of software and hardware.

<Collision-Avoidance Level>

FIG. 7 is a table for illustrating a relationship between an object and a collision-avoidance level according to Embodiment 1. In the selection unit 206 of the edge server 200, the high-level intersection escape routes RESC1 generated by the first escape-route generation unit 204 and the high-level intersection escape routes RESCB2 generated by the second escape-route generation unit 205 are evaluated through calculation of their collision-avoidance levels. The collision-avoidance level is calculated per each of the escape routes such that the risk of collision with an object that may act as an obstacle on the escape route is calculated.

A score of 3 is given when there is no obstacle and thus no object that may collide with the vehicle 801; a score of 2 is given when there is merely a stationary obstacle, which will not collide with the vehicle 801; a score of 1 is given when there is a moving obstacle, which will, however, not collide with the vehicle 801 because of the difference in moving direction or the like; and a score of 0 is given when there is an obstacle that may possibly cause a collision, or there is an obstacle whose possibility of collision is unclear. These scores are just an example and thus, whenever necessary, the scores may be changed with the addition, deletion or change of one or more conditions.

The collision-avoidance level is calculated per each of the escape routes. The route for collision avoidance, that is associated with the collision-avoidance level, may be deactivated on the basis of the abnormality information about the roadside monitoring device. Namely, when an abnormal state of the roadside monitoring device is detected, the score of the collision-avoidance level of the escape route generated on the basis of the roadside monitored information IRSU obtained by that roadside monitoring device is changed to 0.

Further, the edge server 200 monitors the state of communication between the roadside monitoring devices 110, 120 and the edge server 200. When a delay of a predetermined time or more occurs in communication with a specific roadside monitoring device, the score of the collision-avoidance level of the escape route generated on the basis of the roadside monitored information obtained by that roadside monitoring device is changed to 0.

FIG. 8 is a table for illustrating a relationship between a stop position and a collision-avoidance level addition score according to Embodiment 1. When a stop position as an end point of each of the first escape routes RESC1 and the second escape routes RESC2 generated by the first escape-route generation unit 204 and the second escape-route generation unit 205, respectively, corresponds to a stoppable area, a score is added to the collision-avoidance level. How to add an addition score may be determined by the designer voluntarily. For example, the addition score may be set to “+3” when the stop position is placed in a station stopping lot, a stopping lane or a time-limited parking zone; “+2” when it is placed in a roadside strip; and “+1” when it is placed on a road shoulder. These addition scores are just an example and thus, whenever necessary, the addition scores may be changed with the addition, deletion or change of one or more conditions.

In this manner, in the selection unit 206 of the edge server 200, the collision-avoidance level of each of the escape routes is calculated and the addition score is added thereto, to thereby evaluate the escape routes by using scores. Then, from among escape routes per each of the multiple types of abnormal-time travelable distances, an escape route whose score of the collision-avoidance level is highest is selected as the high-level intersection escape route RESCB. Then, the edge server 200 transmits each said high-level intersection escape route RESCB to the driving device 300.

It is noted that the candidate places of the stoppable area, such as a station stopping lot, a stopping lane, a time-limited parking zone, a roadside strip and a road shoulder, where the passengers can properly get off the vehicle, are being recorded in the map. The collision-avoidance level addition scores for the respective candidate places of the stoppable area may be listed in the map information.

<Abnormal-Time Travelable Distance>

FIG. 9 is a first table for illustrating a relationship between an abnormal state of a vehicle and a travelable distance thereof according to Embodiment 1. The driving control device 320 includes a travelable distance calculation unit 306. The travelable distance calculation unit 306 determines the abnormality level and the abnormal-time travelable distance, according to the abnormal state calculated by the vehicle abnormal state detection unit 305. FIG. 9 shows how much distance the vehicle is allowed to travel at the occurrence of an abnormality therein.

When there is no abnormality in the driving device 300, the abnormality level is assigned to 0 and the abnormal-time travelable distance is assigned to L3 (first distance). As a specific example, the abnormal-time travelable distance L3 is exemplified by 100 m. Next, let's assume the case of a minor abnormality that does not affect the traveling. A case where a temporary-abnormality detection flag of one of the object sensor 303 and the multiple sensors for the host-vehicle position detection unit 301 is High, corresponds to that case. Specifically, let's assume the case where a temporary failure occurred but it has currently returned to the normal state. In this case, the abnormality level is assigned to 1 and the abnormal-time travelable distance is assigned to L3.

When one of the object sensor 303 and the multiple sensors for the host-vehicle position detection unit 301 is failed, the abnormality level is assigned to 2 and the abnormal-time travelable distance is assigned to L2 (second distance). As a specific example, the abnormal-time travelable distance L2 is exemplified by 30 m. At this time, an abnormality of a weather sensor may be excluded from the conditions for assignment. This is because an abnormality of the weather sensor does not cause a serious impact on the traveling performance of the autonomous driving vehicle, in many cases.

When more than one of the object sensor 303 and the multiple sensors for the host-vehicle position detection unit 301 are failed, the abnormality level is assigned to 3 and the abnormal-time travelable distance is assigned to L1 (third distance). As a specific example, the abnormal-time travelable distance L1 is exemplified by 15 m.

FIG. 10 is a second table for illustrating a relationship between an abnormal state and a travelable distance according to Embodiment 1. This figure differs from FIG. 9 in that the items of an abnormality level 1.5 and an abnormality level 4 are added. Description will be made only on these different items.

While an abnormality of the weather sensor is a factor outside the travel design region, in many cases, the vehicle is determined to be travelable even with that abnormality. Thus, for that abnormality, the abnormality level is assigned to 1.5 and the abnormal-time travelable distance is assigned to L2.5 (fourth distance). As a specific example, the abnormal-time travelable distance L2.5 is exemplified by 50 m.

In addition, when, because of an abnormality of the motor for driving or the brake, it is difficult to cause the vehicle 801 to move, the abnormality level is assigned to 4 and the abnormal-time travelable distance is assigned to L0 (fifth distance). As a specific example, the abnormal-time travelable distance L0 is exemplified by 0 m. Namely, the vehicle is not caused to travel for escaping from the intersection but is caused to immediately make a stop.

As described above, the abnormal-time travelable distance is calculated by the travelable distance calculation unit 306 on the basis of the vehicle abnormal state detected by the vehicle abnormal state detection unit 305. Then, the intersection escape route corresponding to the abnormal-time travelable distance is selected by the secondary selection unit 311 of the traveling route change unit 307.

Meanwhile, description will be made on a tire air pressure sensor that may be included in the vehicle 801 and an abnormal-time travelable distance. If the tire air pressure is outside a predetermined range of standard values, it is allowed to set the abnormal-time travelable distance after changing it according to the shifted amount from the range of standard values. This is because, when the tire air pressure varies, the distance of movement of the vehicle per one rotation of the wheel varies to thereby affect the calculation of the host vehicle position.

Furthermore, it is allowed to set the abnormal-time travelable distance after changing it on the basis of an abnormality of the host vehicle position calculated using the host-vehicle position detection unit 301. The abnormality degree of the host vehicle position can be determined in such a manner that the calculated host vehicle position is compared with a host vehicle position determined from the relative positions between the vehicle 801 and a topographical landmark and a building, an object and a sign acting as landmarks, that are detected by the object sensor 303. The abnormal-time travelable distance may be set after being changed according to the abnormality degree of the host vehicle position.

When a GNSS is used for the host-vehicle position detection unit 301, it is allowed to set the abnormal-time travelable distance after changing it according to an abnormal state in positioning of the GNSS. With respect to the positioning by the GNSS, the positioning accuracy may be affected due to: accuracy degradation of a receiver device provided in the vehicle 801; degradation in a radio-wave state of the positioning satellite; accuracy degradation of a chronometer of the positioning satellite; orbital deviation of the positioning satellite; or the like. The driving control device 320 can detect an abnormal state in positioning of the GNSS to thereby set the abnormal-time travelable distance after changing it according to the degree of the abnormal state.

Further, it is allowed to set the abnormal-time travelable distance after changing it according to an abnormal state of the gyro sensor that may be included in the vehicle 801. For example, it is allowed to set the abnormal-time travelable distance after changing it according to a drift amount of the gyro sensor. This is useful because if the gyro sensor becomes abnormal, an error in the host vehicle position calculated on the basis of the output of the gyro sensor will be accumulated to the extent corresponding to the travel distance of the vehicle.

Further, it is allowed to set the abnormal-time travelable distance after changing it according to the degree of an abnormal state of the weather sensor that may be included in the vehicle 801. This is useful because, although the abnormality of the weather sensor does not directly affect the position detection of the vehicle in many cases, it may affect the position detection on a medium or long-term basis.

Further, it is allowed to monitor an amount of a delay in communication that is established by the communication module 302 included in the driving device 300, to thereby set the abnormal-time travelable distance after changing it on the basis of a state of the communication delay. This is useful because the occurrence of a delay in the communication causes a delay in object recognition using external information.

<Selection of Intersection Escape Route>

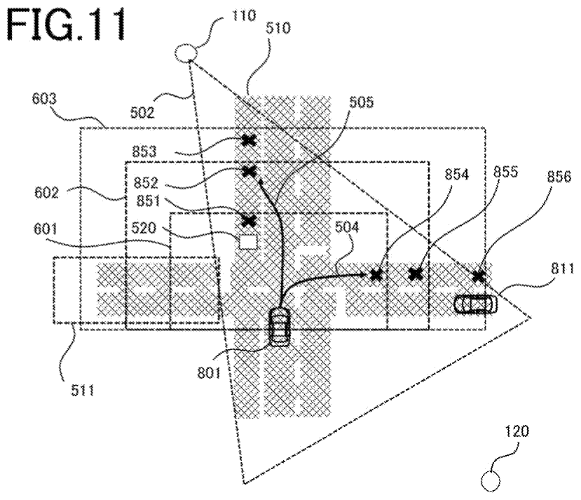

FIG. 11 is a diagram for illustrating intersection escape routes according to Embodiment 1. In FIG. 11, the abnormal-time travelable distances are visually represented. FIG. 11 shows a case where an abnormality occurs in each of the driving device 300 and the roadside monitoring device 120 after the vehicle 801 enters the intersection.

There are shown a travelable area 601, a travelable area 602 and a travelable area 603. These travelable areas correspond to the abnormal-time travelable distances L1, L2, L3 each determined according to a vehicle abnormal state. The travelable distance means a distance of movement allowed for the vehicle 801 to travel from when the driving device 300 detects an abnormality to when the vehicle comes to an emergency stop. The range for that distance is set using positional information, for example, a movement distance limit, a latitude and longitude and the like. The travelable areas stated in FIG. 11 are defined on the basis of the respective travelable distances. Specifically, when the abnormal-time travelable distances are set with a relationship of L3>L2>L1, the dimensions of the respective areas are set with a relationship of the travelable area 603>the travelable area 602>the travelable area 601.

The abnormal-time travelable distances are each calculated by the travelable distance calculation unit 306 on the basis of the vehicle abnormal state detected by the vehicle abnormal state detection unit 305. When the abnormality level is to be 0 or 1, the abnormal-time travelable distance is set to L3 (the travelable area 603 is specified). On this occasion, there is no abnormality in the driving device 300 or there is a minor abnormality that does not affect the driving. A case where the temporary-abnormality detection flag of one of the object sensor 303 and the multiple sensors for the host-vehicle position detection unit 301 is High, corresponds to that case.

When the abnormality level is to be 2, the abnormal-time travelable distance is set to L2 (the travelable area 602 is specified). This assumes that an abnormal state of one of the object sensor 303 and the multiple sensors continues.

When the abnormality level is to be 3, the abnormal-time travelable distance is set to L1 (the travelable area 601 is specified). As a corresponding abnormal state, failures of plural sensors are assumed.

Such a case is exemplified that because of the detection of abnormalities of the GNSS and the yaw rate sensor, for example, the driving device 300 can determine that the vehicle will be difficult to travel by a distance corresponding to a range of the abnormal-time travelable distance L2 or more. When the abnormal-time travelable distance is L1, escape from the intersection is prioritized.

When the abnormality level is to be 4, the abnormal-time travelable distance is set to L0. A case where because of an abnormality of the motor for driving or the brake, it is difficult to cause the vehicle 801 to move, corresponds to that case. Only in this case, the driving device 300 is impossible to mechanically cause the vehicle 801 to move. Accordingly, when the driving device 300 detects the relevant abnormality at a spot, it causes the vehicle 801 to stop immediately at that spot.

In this manner, according to the vehicle 801 whose abnormal-time travelable distance is restricted depending on the abnormality level by the driving device 300, the movable range thereof from a spot where the abnormality is detected to a specified stop position, is restricted. In that range, it is necessary to make a stop at a spot where the risk of collision with an obstacle is low.

For that reason, using the abnormal-time travelable distance outputted from the travelable distance calculation unit 306 as input information, the normal-time target route is changed to a vehicle abnormal-time escape route different therefrom, as described below. This processing is executed by the traveling route change unit 307.

When the abnormal-time travelable distance is set to L3 by the travelable distance calculation unit 306 (the travelable area 603 is specified), a target stop position 853 or 856 is given as the end point of the escape route. In FIG. 11, because the roadside monitoring device 120 is in an abnormal state, it is required to select a target stop position within the viewing angle 502 of the roadside monitoring device 110.

The target stop position 856 is improper since it is outside the viewing angle 502. Note that a left-turn route is excluded from the candidates for the escape route of a vehicle 802. An area 511 is excluded from the candidate areas since it is placed outside the viewing angle 502 of the roadside monitoring device 110 and thus cannot be monitored.

Although an obstacle 520 exists in the middle of an escape route 505, this route is determined to have the collision-avoidance level 2 since the obstacle is a stationary object that will not cause the collision. Then, since the target stop position 853 is placed in a stoppable area 510 as a stopping lane, the score +3 is added to the collision-avoidance level.

Accordingly, when the target stop position 853 is adopted by way of the escape route 505, the collision-avoidance level is evaluated to be 5 and that route will be selected by the secondary selection unit 311. This means that, in a travel restricted range, such a stoppable area could be selected that can avoid the collision more surely than in the case where the vehicle stops at a spot just after turning right.

When the abnormal-time travelable distance is set to L2 (the travelable area 602 is specified), a target stop position 852 or 855 is given as the end point of the escape route. In FIG. 11, the target stop positions 852, 855 both fall within the viewing angle 502 of the roadside monitoring device 110.

Although the obstacle 520 exists in the middle of the escape route 505 reaching the target stop position 852, this route is determined to have the collision-avoidance level 2 since the obstacle is a stationary object that will not cause the collision. Then, since the target stop position 852 is placed in the stoppable area 510 as a stopping lane, the score +3 is added to the collision-avoidance level. Accordingly, when the target stop position 852 is adopted by way of the escape route 505, the collision-avoidance level is evaluated to be 5.

An escape route 504 reaching a target stop position 855 gets across the course of the vehicle 811. This means that there is a moving object that will not cause the collision, so that the collision-avoidance level 1 is given to that route. When the target stop position 855 is placed on a road shoulder of the traveling course, the addition score for the collision-avoidance level is +1. Accordingly, when the target stop position 855 is adopted by way of the escape route 504, the collision-avoidance level is evaluated to be 2. In this case, the escape route 505 with the target stop position 852 will be selected by the secondary selection unit 311. This means that, in the abnormal-time travelable distance L2, such a stoppable area could be selected that is higher in collision-avoidance level than in the case where the vehicle stops at a spot just after turning right.

When the abnormal-time travelable distance is set to L1 (the travelable area 601 is specified), a target stop position 851 or 854 is given as the end point of the escape route. In FIG. 11, the target stop positions 851, 854 both fall within the viewing angle 502 of the roadside monitoring device 110. Since the obstacle 520 exists immediately near the target stop position 851 and thus may cause the collision, the collision-avoidance level is determined to be 0.

It is noted that, since the target stop position 851 exists in the stoppable area 510 as a stopping lane, the score +3 is to be added to the collision-avoidance level under ordinary circumstances. However, since the target stop position 851 is a physically unstoppable place because of the presence of the obstacle 520 therearound, the addition score is invalidated. Accordingly, the collision-avoidance level of the escape route to the target stop position 851 is evaluated to be 0.

The escape route 504 reaching the target stop position 854 gets across, at a middle thereof, the course of the vehicle 811. Thus, the collision-avoidance level is 1. When the target stop position 854 is placed on a road shoulder of the traveling route, the addition score for the collision-avoidance level is +1. Accordingly, when the target stop position 854 is adopted by way of the escape route 504, the collision-avoidance level is evaluated to be 2. In this case, the escape route 504 with the target stop position 854 will be selected by the secondary selection unit 311.

<Processing by Edge Server>

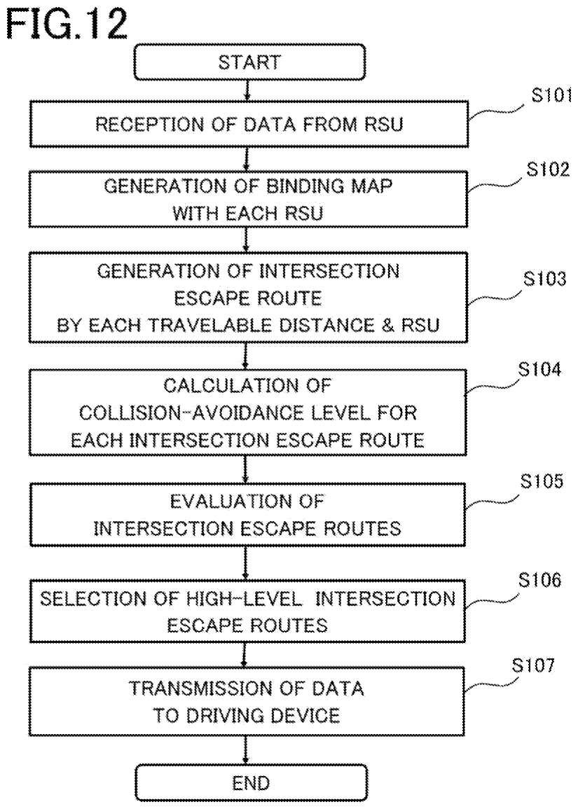

FIG. 12 is a flowchart showing processing by the edge server 200 according to Embodiment 1. The processing shown in FIG. 12 is executed by the arithmetic processing device in the edge server 200. The processing may be executed every fixed period of time (for example, every 5 ms). It is allowed that the processing is not executed every fixed period of time but executed in response to an event, such as, data reception by the communication module 201, or the like.

Upon starting the processing of FIG. 12, in Step S101, the edge server receives data from each of the roadside monitoring devices (in the figure, abbreviated as RSU). It receives, through the communication module 201, the object information, the viewing angle information of the sensors and information related to an abnormal state of the sensor.

In Step S102, per each of the roadside monitoring devices, binding map information resulting from superimposing the roadside monitored information received from the roadside monitoring device on the map information is generated. Specifically, the map generation unit 202 of the edge server 200 transfers the first binding map information IOBM1 resulting from superimposing the roadside monitored information according to the roadside monitoring device 110 on the map information 208, to the first escape-route generation unit 204. Further, the map generation unit 202 transfers the second binding map information IOBM2 resulting from superimposing the roadside monitored information according to the roadside monitoring device 120 on the map information 208, to the second escape-route generation unit 205.

In Step S103, on the basis of the binding map information generated per each said roadside monitoring device, intersection escape routes for the respective ones of the abnormal-time travelable distances are generated. In Step S104, a collision-avoidance level is calculated per each said intersection escape route. At this time, an addition score for collision-avoidance level is also added thereto.

In Step S105, the collision-avoidance levels are compared with each other to thereby evaluate the intersection escape routes. In Step S106, intersection escape routes having highest collision-avoidance levels are selected as the high-level intersection escape routes RESCB. The high-level intersection escape routes RESCB are selected by the selection unit 206 for the respective ones of the abnormal-time travelable distances.

In Step S107, the thus-selected high-level intersection escape routes RESCB are transmitted to the driving device. Specifically, the high-level inter-section escape routes RESCB selected by the selection unit 206 for the respective ones of the abnormal-time travelable distances are transferred through the communication module 207 to the driving device 300. At this time, the abnormality information FRSU related to each of the roadside monitoring devices is also transferred through the communication module 207 to the driving device 300. Thereafter, the processing is terminated.

<Processing by Driving Device>

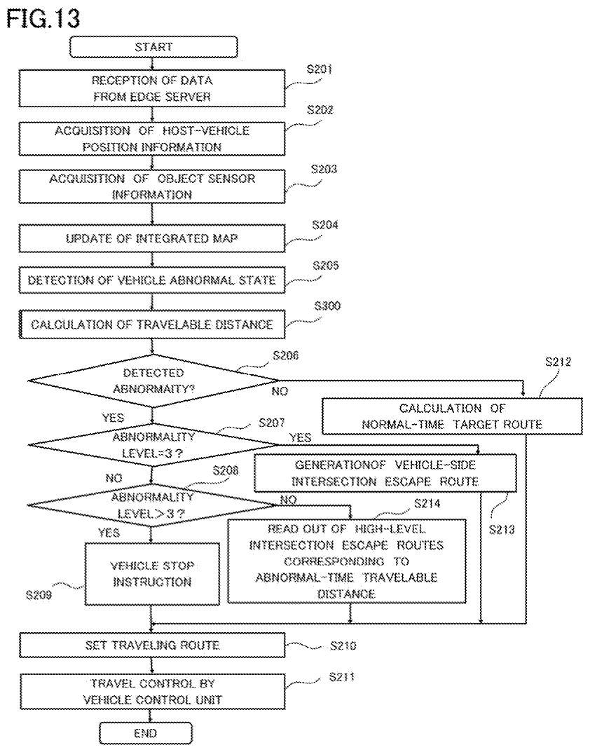

FIG. 13 is a flowchart showing processing by the driving device 300 according to Embodiment 1. The processing shown in FIG. 13 is executed by the arithmetic processing device in the driving device 300. The processing may be executed every fixed period of time (for example, every 5 ms). It is allowed that the processing is not executed every fixed period of time but executed in response to an event, such as, a data reception by the communication module 302, a travel of the vehicle 801 by a fixed distance, or the like.

Upon starting the processing of FIG. 13, in Step S201, the driving device 300 receives data from the edge server 200. Specifically, the communication module 302 receives the binding map information IOBM, the high-level inter-section escape routes RESCB, etc. to be received from the edge server 200.

In Step S202, the driving device 300 acquires the host-vehicle position information. Specifically, the host-vehicle position detection unit 301 calculates the host-vehicle position by using: positioning information from the GNSS (Global Navigation Satellite System) that detects the host vehicle position; the travel distance sensor that detects the wheel rotation number of the vehicle 801; the gyro sensor that detects the acceleration, speed, angular acceleration and angular speed of the vehicle 801; and the like.

In Step S203, the driving device 300 acquires the object sensor information. Specifically, it acquires the information of the object sensor 303 that detects the position, the speed and the type of an object around the vehicle.

In Step S204, the integrated map 316 is updated. The map information integration unit 304 receives the host-vehicle position information IS outputted from the host-vehicle position detection unit 301 and the object sensor information IO outputted by the object sensor 303. Furthermore, the map information integration unit 304 receives the binding map information IOBM and the high-level intersection escape routes RESCB that the communication module 302 has received from the edge server 200. The map information integration unit 304 uses, as its inputs, these sets of information, to integrate the object information detected by the data collection device 100 and that detected by the driving device 300, to thereby update the integrated map 316.

In Step S205, the driving device 300 detects the vehicle abnormal state. An abnormality of the object sensor 303, the host-vehicle position detection unit 301 or the like, is detected by the vehicle abnormal state detection unit 305.

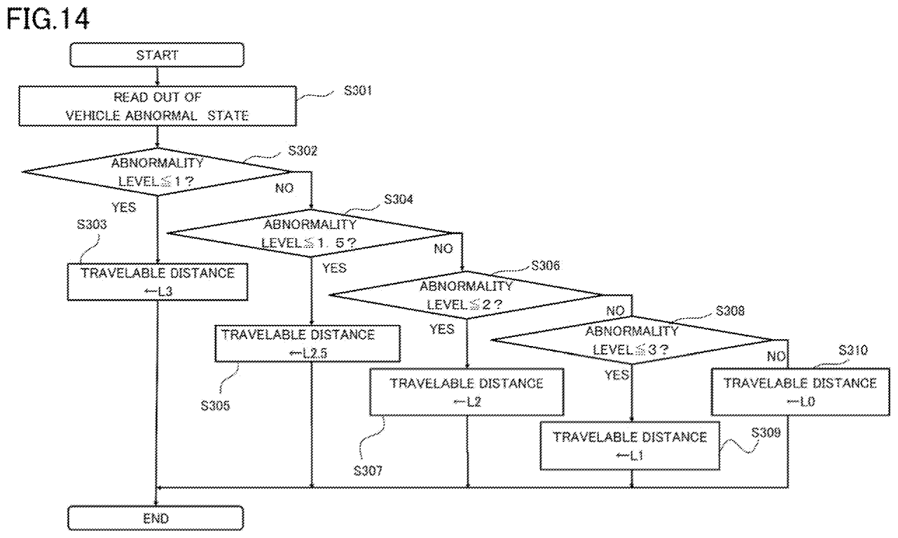

In Step S300, using the travelable distance calculation unit 306, the driving device 300 calculates the travelable distance. The travelable distance is calculated according to the detected vehicle abnormal state. Processing details of Step S300 are described in FIG. 14.

In Step S206, whether or not the abnormality has been detected by the vehicle abnormal state detection unit 305 is determined. If there is the abnormality (judgement is YES), the flow moves to Step S207. If there is no abnormality (judgement is NO), the flow moves to Step S212, where the normal-time target route calculation unit 308 calculates the normal-time target route. Thereafter, the flow moves to Step S210.

In Step S207, whether or not the abnormality level of the vehicle is 3 is determined. If it is not 3 (judgement is NO), the flow moves to Step S208. If the abnormality level of the vehicle is 3 (judgement is YES), the flow moves to Step S213, where a vehicle-side intersection escape route is generated. In order for the vehicle to prioritize escape from the intersection when a vehicle abnormal state of the abnormality level 3 is detected, the vehicle-side escape route generation unit 309 generates the intersection escape route on the basis of the integrated map 316. Thereafter, the flow moves to Step S210.

In Step S208, whether or not the abnormality level of the vehicle is more than 3 is determined. If it is more than 3 (judgement is YES), the flow moves to Step S209, where a vehicle stop instruction is issued, and then the flow moves to Step S210. This is because, since the abnormality level of the vehicle is 4, the vehicle is difficult to escape the intersection and should stop immediately. In Step S208, if the abnormality level of the vehicle is not more than 3 (judgement is NO) (that is, the abnormality level of the vehicle is 1 or 2), the flow moves to Step S214, where the high-level intersection escape route RESCB corresponding to the abnormal-time travelable distance is read out. Thereafter, the flow moves to Step S210.

In Step S210, the route that was generated or read out just before is set as the traveling route. Then, in Step S211, traveling control of the vehicle is executed by the vehicle control unit 312. Thereafter, the processing is terminated.

<Calculation Processing of Travelable Distance>

FIG. 14 is a flowchart of the driving device 300 according to Embodiment 1, showing calculation processing of the travelable distance to be performed by the travelable distance calculation unit 306 on the basis of FIG. 10. In FIG. 14, processing details of Step S300 in FIG. 13 are described.

In Step S301, the abnormal state in the driving device 300 detected by the vehicle abnormal state detection unit 305 is read out. In Step S302, whether or not the abnormality level is equal to or less than 1 is determined. If the abnormality level is equal to or less than 1 (judgement is YES), the flow moves to Step S303, where the travelable distance is set to L3, and then the processing is terminated.

In Step S302, if the abnormality level is not equal to or less than 1 (judgement is NO), the flow moves to Step S304. In Step S304, whether or not the abnormality level is equal to or less than 1.5 is determined. If the abnormality level is equal to or less than 1.5 (judgement is YES), the flow moves to Step S305, where the travelable distance is set to L2.5, and then the processing is terminated.

In Step S304, if the abnormality level is not equal to or less than 1.5 (judgement is NO), the flow moves to Step S306. In Step S306, whether or not the abnormality level is equal to or less than 2 is determined. If the abnormality level is equal to or less than 2 (judgement is YES), the flow moves to Step S307, where the travelable distance is set to L2, and then the processing is terminated.

In Step S306, if the abnormality level is not equal to or less than 2 (judgement is NO), the flow moves to Step S308. In Step S308, whether or not the abnormality level is equal to or less than 3 is determined. If the abnormality level is equal to or less than 3 (judgement is YES), the flow moves to Step S309, where the travelable distance is set to L1, and then the processing is terminated. In Step S308, if the abnormality level is not equal to or less than 3 (judgement is NO), the flow moves to Step S310. In Step S310, the travelable distance is set to L0, and then the processing is terminated.

### 2. Embodiment 2

<Configuration of Autonomous Driving Integrated Control System>

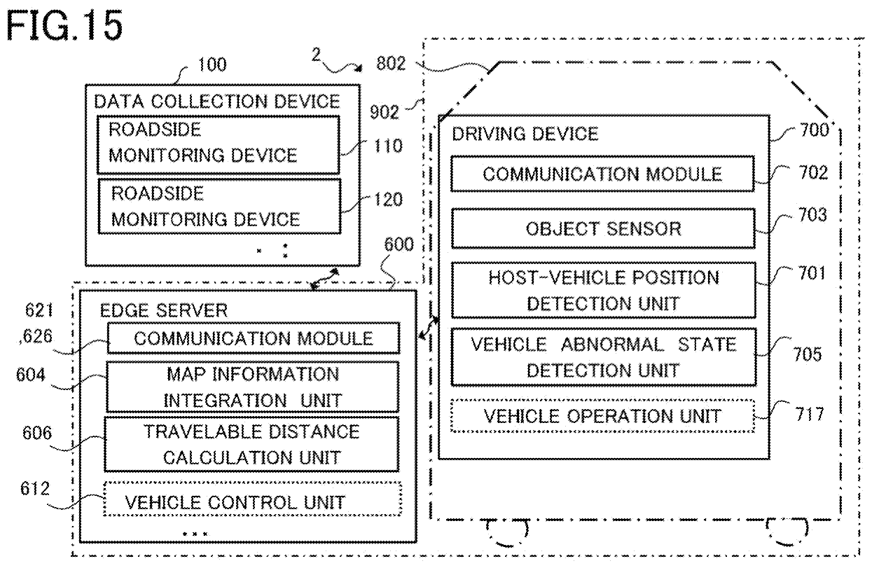

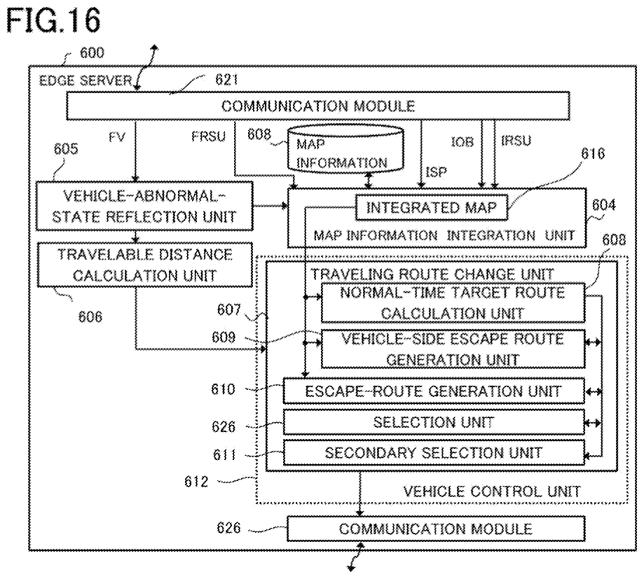

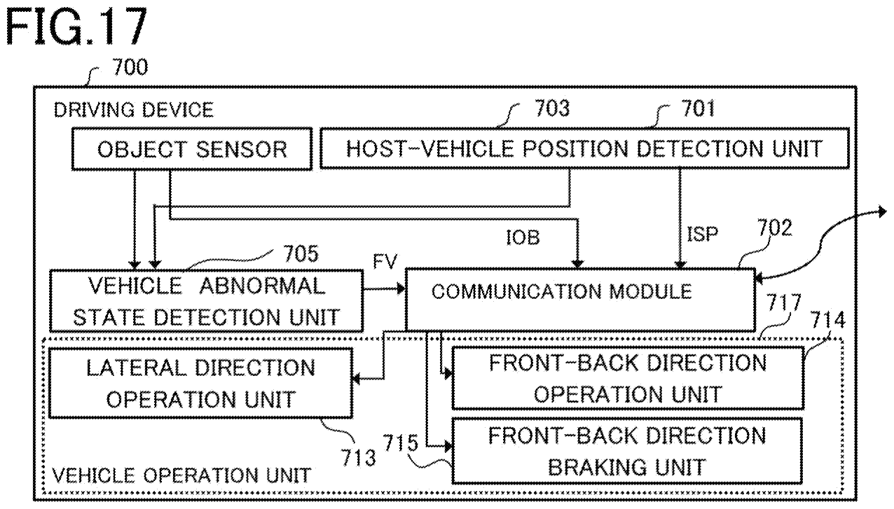

FIG. 15 is an entire configuration diagram of an autonomous driving integrated control system 2 according to Embodiment 2. FIG. 16 is a configuration diagram of an edge server 600 according to Embodiment 2. FIG. 17 is a configuration diagram of a driving device 700 according to Embodiment 2.

A data collection device 100 according to Embodiment 2 is the same as that of Embodiment 1, so that description thereof will be omitted. As shown in FIG. 15 to FIG. 17, the driving device 700 according to Embodiment 2 differs from the driving device 300 according to Embodiment 1 in that the travelable distance calculation unit and the vehicle control unit are functionally transferred to the edge server 600 as a travelable distance calculation unit 606 and a vehicle control unit 612. However, functions established by the autonomous driving integrated control system 2 according to Embodiment 2 as a whole, correspond to the functions established by the autonomous driving integrated control system 1 according to Embodiment 1 as a whole. The edge server 600 and the driving device 700 constitute an autonomous driving device 902 that is provided with the data collection device 100 as its external device.

The driving device 700 according to Embodiment 2 shown in FIG. 17 includes: a host-vehicle position detection unit 701 that detects host-vehicle position information; an object sensor 703 that detects an object around the vehicle; and a vehicle abnormal state detection unit 705 that detects an abnormal state of the vehicle. Host-vehicle position information IS, object information IO and vehicle abnormal-state information FV are transmitted through a communication module 702 to the edge server 600.

High-speed communications are established between the data collection device 100, the communication module 702 of the driving device 700 and communication modules 621, 626 of the edge server 600. Further, the communication module 702 receives vehicle control information transmitted from the edge server 600. According to the vehicle control information, a lateral direction operation unit 713, a front-back direction operation unit 714 and a front-back direction braking unit 715 are operated, so that the vehicle 802 travels autonomously. The lateral direction operation unit 713, the front-back direction operation unit 714 and the front-back direction braking unit 715 are referred to collectively as a vehicle operation unit 717.

The edge server 600 is provided with the communication module 621, so that the host-vehicle position information IS and the object information IO coming from the driving device 700, and the roadside monitored information IRSU and the abnormality information FRSU coming from the roadside monitoring devices 110, 120, are transferred to a map information integration unit 604. Further, the vehicle abnormal-state information FV is transferred to a vehicle-abnormal-state reflection unit 605, so that the travelable distance is calculated by the travelable distance calculation unit 606.

In Embodiment 2, the map information integration unit 604 is included in the edge server 600, although it is included in the driving device 300 in Embodiment 1. When there is no abnormality in the vehicle 802, the roadside monitoring devices 110, 120, etc., an integrated map 616 in which the host-vehicle position information IS, the roadside monitored information IRSU found by the roadside monitoring devices, and the object sensor information IO detected by the vehicle, are superimposed on a map, is updated.

<Processing by Edge Server>

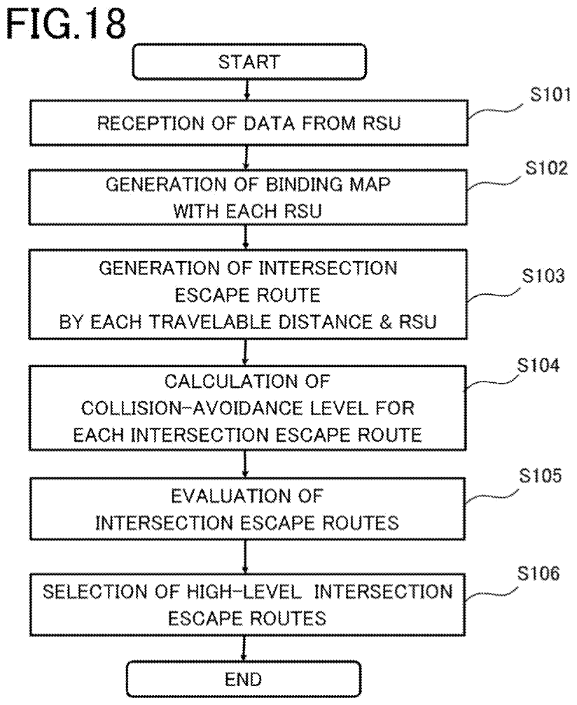

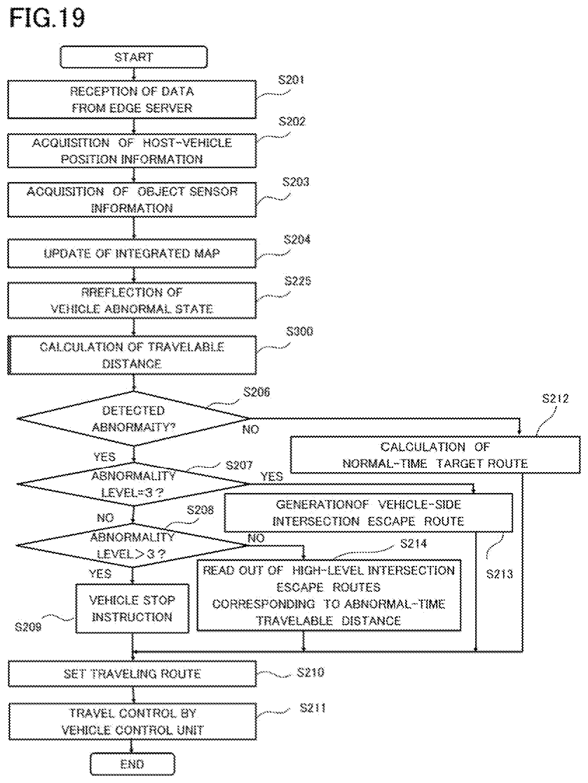

FIG. 18 is a first flowchart showing processing by the edge server 600 according to Embodiment 2. FIG. 19 is a second flowchart showing processing by the edge server.

The processing shown in FIG. 18 is executed by the arithmetic processing device in the edge server 600. The processing may be executed every fixed period of time (for example, every 5 ms). It is allowed that the processing is not executed every fixed period of time but executed in response to an event, such as, a data reception by the communication module 621, or the like.

In the processing of FIG. 18, what differs from the processing of FIG. 12 according to Embodiment 1 is only that Step S107 in FIG. 12 is deleted. In Embodiment 1, data of the high-level intersection escape routes, etc. are transmitted to the driving device, and processing subsequent thereto is left to the driving device.

In Embodiment 2, since the subsequent processing is executed by the edge server 600 itself, the transmission processing is deleted.

The processing shown in FIG. 19 is executed by the arithmetic processing device in the edge server 600. The processing may be executed every fixed period of time (for example, every 5 ms). It is allowed that the processing is not executed every fixed period of time but executed in response to an event, such as, a data reception by the communication module 621, or the like. Further, the processing of FIG. 19 may be executed successively to the processing of FIG. 18.

The processing of FIG. 19 corresponds to the processing of FIG. 13 executed in Embodiment 1 by the driving device 300. They partly differ from each other in that Step S201, Step S205 and Step S211 in FIG. 13 are changed to Step S221, Step S225 and Step S231 in FIG. 19, respectively. Description will be made only on the changed part of the processing. With respect to the other steps, as the execution entity, the driving device 300 shall be read as the edge server 600. As processing details of Step S300 in FIG. 19, the processing of FIG. 14 is employed provided that, as the execution entity, the driving device 300 is read as the edge server 600.

In Step S221 in FIG. 19, the edge server receives data from the driving device 700. The purpose is for the edge server 600 to acquire the host-vehicle position information IS, the object sensor information IO and the vehicle abnormal-state information FV that have been collected by the driving device 700.

In Step S225 in FIG. 19, the vehicle abnormal state is reflected. Since the vehicle abnormal-state information FV has already been received from the driving device 700, there is no need to newly detect the vehicle abnormal state. An operation of referring to the already-received data is stated as “Reflection of Vehicle Abnormal State”.

In Step S231 in FIG. 19, vehicle travel data is transmitted to the driving device 700. In FIG. 13, it is stated that traveling control of the vehicle is executed, since the traveling control is executed by the driving device 300. According to FIG. 19, the edge server 600 generates the vehicle travel data, and then requests the driving device 700 to execute the traveling control.

<Processing by Driving Device>

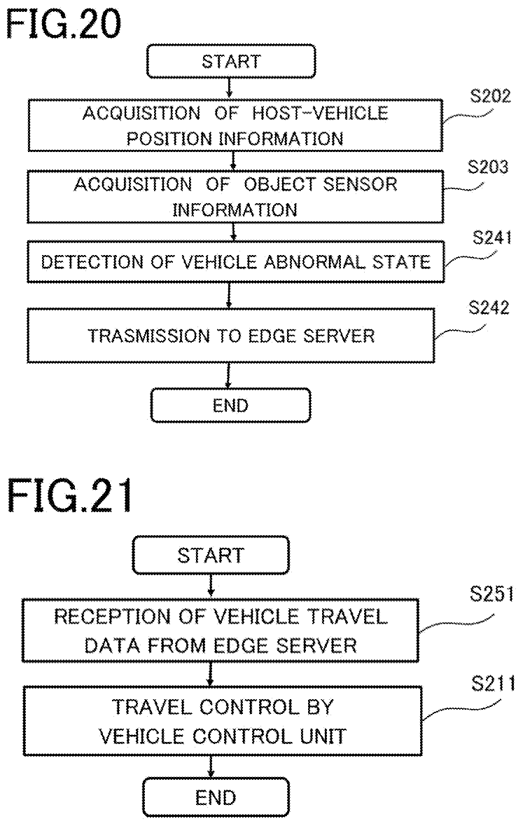

FIG. 20 is a first flowchart showing processing by the driving device 700 according to Embodiment 2. The processing shown in FIG. 20 is executed by the arithmetic processing device in the driving device 700. The processing may be executed every fixed period of time (for example, every 5 ms). It is allowed that the processing is not executed every fixed period of time but executed in response to an event, for example, in response to the completion of each of the detection processes of: the host-vehicle position by the host-vehicle position detection unit 701; an object around the vehicle by the object sensor 703; and the vehicle abnormal state by the vehicle abnormal state detection unit 705.

Upon starting the processing of FIG. 20, in Step S202, the driving device 700 acquires the host-vehicle position information. In Step S203, the driving device 700 acquires the object sensor information. In Step S241, the driving device 700 detects the vehicle abnormal state. In Step S242, the driving device 700 transmits the host-vehicle position information, the object information and the vehicle abnormal-state information, to the edge server 600 through the communication module 702. Then, the processing is terminated.

FIG. 21 is a second flowchart showing processing by the driving device 700 according to Embodiment 2. The processing shown in FIG. 21 is executed by the arithmetic processing device in the driving device 700. The processing may be executed every fixed period of time (for example, every 5 ms). It is allowed that the processing is not executed every fixed period of time but executed in response to an event, such as, a data reception by the communication module 702, or the like.

Upon starting the processing of FIG. 21, in Step S251, the communication module 702 receives the vehicle travel data from the edge server 600. Then, in Step S211, according to the vehicle control information, the communication module 702 transfers operation signals to the vehicle operation unit 717. Namely, it transfers the operation signals to the lateral direction operation unit 713, the front-back direction operation unit 714 and the front-back direction braking unit 715, to thereby cause the vehicle 802 to travel autonomously. Then, the processing is terminated.

According to Embodiment 2, since some functions that the driving device 700 installed in the vehicle 802 would have had, are transferred to the edge server 600, it is possible to achieve reduction in size and weight of the driving device 700. Accordingly, it is also possible to achieve cost reduction of the driving device 700 and saving of works related to specification change thereof. Specifically, it is possible to achieve capacity reduction and shrinkage of a CPU or a memory mounted in the driving device 700. Further, although the driving device 700 to be installed in the vehicle 802 has a limit in its capacity, the edge server 600 to be placed outside the vehicle 802 is not so severely restricted in its capacity because the contents of processing may be shared by many pieces of hardware. Accordingly, this configuration is advantageous for execution of a large amount of processes at high speed.

In this disclosure, a variety of exemplary embodiments and examples are described; however, every characteristic, configuration or function that is described in one or more embodiments, is not limited to being applied to a specific embodiment, and may be applied singularly or in any of various combinations thereof to another embodiment. Accordingly, an infinite number of modified examples that are not exemplified here are supposed within the technical scope disclosed in the present description. For example, such cases shall be included where at least one configuration element is modified; where at least one configuration element is added or omitted; and furthermore, where at least one configuration element is extracted and combined with a configuration element of another embodiment.

Various embodiments disclosed above are summarized in the following appendices.

### (Appendix 1)

An autonomous driving integrated control system, comprising multiple roadside monitoring devices and an autonomous driving device,
said multiple roadside monitoring devices each having:
a sensor that detects a nearby object; and
a transmitter that transmits viewing angle information of the sensor and information of the object detected by the sensor; and
said autonomous driving device having:
a receiver unit that receives the viewing angle information and the information of the object from the transmitter of each of the roadside monitoring devices;
a vehicle abnormal state detection unit that detects an abnormal state of a vehicle;
an escape route generation unit that generates, per each of the roadside monitoring devices and per each of multiple abnormal-time travelable distances, an intersection escape route for escaping from an intersection at an occurrence of abnormality in the vehicle entering the intersection, on a basis of the sets of information received from the roadside monitoring devices;
a selection unit that compares the respective intersection escape routes generated by the escape route generation unit, with each other in terms of their collision-avoidance levels each indicating a likelihood that the vehicle during travel on the intersection escape route will avoid a collision with the object, to thereby select, per each of the abnormal-time travelable distances, the intersection escape route having a highest collision-avoidance level as a high-level intersection escape route;
a travelable distance calculation unit that, when the abnormal state of the vehicle is detected by the vehicle abnormal state detection unit, calculates an abnormal-time travelable distance corresponding to one of said abnormal-time travelable distances and suited to the abnormal state;
a vehicle control unit that, when the abnormal state of the vehicle entering the intersection is detected by the vehicle abnormal state detection unit, outputs a command signal for causing the vehicle to travel along, among the high-level intersection escape routes selected by the selection unit, the high-level intersection escape route corresponding to the abnormal-time travelable distance calculated by the travelable distance calculation unit; and
a vehicle operation unit that activates an actuator by using the command signal outputted by the vehicle control unit.

### (Appendix 2)

The autonomous driving integrated control system as set forth in Appendix 1, wherein the selection unit of the autonomous driving device determines the collision-avoidance level to be “3” when no object is detected on the intersection escape route; to be “2” when a stationary object exists on the intersection escape route but will not cause a collision; to be “1” when a moving object exists on the intersection escape route but will not cause a collision; and to be “0” when an object exists on the intersection escape route and will cause a collision or its possibility of collision is unclear.

### (Appendix 3)

The autonomous driving integrated control system as set forth in Appendix 2, wherein, to the collision-avoidance level, the selection unit of the autonomous driving device adds “+3” when a stop point as an end point of the intersection escape route is placed in a station stopping lot, a stopping lane or a time-limited parking zone; adds “+2” when the stop point of the intersection escape route is placed in a roadside strip; and adds “+1” when the stop point of the intersection escape route is placed on a road shoulder.

### (Appendix 4)

The autonomous driving integrated control system as set forth in any one of Appendices 1 to 3, wherein the autonomous driving device has multiple in-vehicle sensors that are installed in the vehicle and each detect a nearby object; and

wherein the travelable distance calculation unit of the autonomous driving device sets as the abnormal-time travelable distance, a predetermined first distance when one of the in-vehicle sensors temporarily causes a failure; a predetermined second distance that is shorter than the first distance, when one of the in-vehicle sensors continuously causes a failure; and a predetermined third distance that is shorter than the second distance, when more than one of the in-vehicle sensors continuously cause failures.

### (Appendix 5)

The autonomous driving integrated control system as set forth in any one of Appendices 1 to 3, wherein the autonomous driving device has multiple in-vehicle sensors that are installed in the vehicle and each detect a nearby object, and a weather sensor that is installed in the vehicle and detects nearby weather conditions;

wherein the travelable distance calculation unit of the autonomous driving device sets as the abnormal-time travelable distance, a predetermined first distance when one of the in-vehicle sensors temporarily causes a failure; a predetermined fourth distance that is shorter than the first distance, when the weather sensor causes a failure; a predetermined second distance that is shorter than the fourth distance, when one of the in-vehicle sensors continuously causes a failure; a predetermined third distance that is shorter than the second distance, when more than one of the in-vehicle sensors continuously cause failures; and a predetermined fifth distance that is shorter than the third distance, when a drive mechanism or a brake mechanism of the vehicle causes a failure.

### (Appendix 6)

The autonomous driving integrated control system as set forth in Appendix 5, wherein the travelable distance calculation unit of the autonomous driving device sets to zero the fifth distance as the abnormal-time travelable distance.

### (Appendix 7)

The autonomous driving integrated control system as set forth in any one of Appendices 1 to 6, wherein the autonomous driving device has multiple in-vehicle sensors that are installed in the vehicle and each detect a nearby object; and
wherein the vehicle control unit of the autonomous driving device has:
a vehicle-side escape route generation unit that generates, with respect to a predetermined vehicle-side-escape-route generation distance, an intersection escape route for escaping from the intersection and then making a stop at an occurrence of abnormality in the vehicle entering the intersection, on a basis of the information received from the roadside monitoring devices and information detected by the in-vehicle sensors, to thereby set the thus-generated intersection escape route as a vehicle-side intersection escape route; and
a secondary selection unit that, when the abnormal state of the vehicle entering the intersection is detected by the vehicle abnormal state detection unit, selects the high-level intersection escape route corresponding to the abnormal-time travelable distance calculated by the travelable distance calculation unit when said abnormal-time travelable distance is longer than the vehicle-side-escape-route generation distance; and selects the vehicle-side intersection escape route generated by the vehicle-side escape route generation unit when the abnormal-time travelable distance calculated by the travelable distance calculation unit is equal to or less than the vehicle-side-escape-route generation distance; and
wherein the vehicle control unit outputs the command signal or a command signal for causing the vehicle to travel along the high-level intersection escape route or the vehicle-side intersection escape route selected by the secondary selection unit.

### (Appendix 8)

The autonomous driving integrated control system as set forth in any one of Appendices 4 to 6, wherein the vehicle control unit of the autonomous driving device has:
a vehicle-side escape route generation unit that generates, with respect to the third distance, an intersection escape route for escaping from the intersection and then making a stop at an occurrence of abnormality in the vehicle entering the intersection, on a basis of the information received from the roadside monitoring devices and information detected by the in-vehicle sensors, to thereby set the thus-generated intersection escape route as a vehicle-side intersection escape route; and
a secondary selection unit that, when the abnormal state of the vehicle entering the intersection is detected by the vehicle abnormal state detection unit, selects the high-level inter-section escape route corresponding to the abnormal-time travelable distance calculated by the travelable distance calculation unit when said abnormal-time travelable distance is the first distance or the second distance; and selects the vehicle-side intersection escape route generated by the vehicle-side escape route generation unit when the abnormal-time travelable distance calculated by the travelable distance calculation unit is the third distance; and
wherein the vehicle control unit outputs the command signal or a command signal for causing the vehicle to travel along the high-level intersection escape route or the vehicle-side intersection escape route selected by the secondary selection unit.

### (Appendix 9)

The autonomous driving integrated control system as set forth in any one of Appendices 4 to 8, wherein the in-vehicle sensors of the autonomous driving device include at least one of a GNSS, a gyro sensor and a tire air pressure sensor.

### (Appendix 10)

The autonomous driving integrated control system as set forth in any one of Appendices 1 to 9, wherein the abnormal state of the vehicle to be detected by the vehicle abnormal state detection unit of the autonomous driving device, includes a delay in communication, and the travelable distance calculation unit of the autonomous driving device calculates the abnormal-time travelable distance according to an amount of the delay in communication.

### (Appendix 11)

The autonomous driving integrated control system as set forth in any one of Appendices 1 to 10, wherein the abnormal state of the vehicle to be detected by the vehicle abnormal state detection unit of the autonomous driving device, includes a positional abnormality of the vehicle, and the travelable distance calculation unit of the autonomous driving device calculates the abnormal-time travelable distance according to an amount of the positional abnormality of the vehicle.

### (Appendix 12)

The autonomous driving integrated control system as set forth in Appendices 1 to 11, wherein the abnormal state of the vehicle to be detected by the vehicle abnormal state detection unit of the autonomous driving device, includes a positioning abnormality of a GNSS installed in the vehicle, and the travelable distance calculation unit of the autonomous driving device calculates the abnormal-time travelable distance according to a state of the positioning abnormality of the GNSS.

### (Appendix 13)

The autonomous driving integrated control system as set forth in any one of Appendices 1 to 12, wherein the abnormal state of the vehicle to be detected by the vehicle abnormal state detection unit of the autonomous driving device includes an abnormality of a gyro sensor installed in the vehicle, and the travelable distance calculation unit of the autonomous driving device calculates the abnormal-time travelable distance according to a state of the abnormality of the gyro sensor.

### (Appendix 14)

The autonomous driving integrated control system as set forth in any one of Appendices 1 to 13, wherein the abnormal state of the vehicle to be detected by the vehicle abnormal state detection unit of the autonomous driving device, includes an abnormality of a weather sensor installed in the vehicle, and the travelable distance calculation unit of the autonomous driving device calculates the abnormal-time travelable distance according to a state of the abnormality of the weather sensor.

### (Appendix 15)

The autonomous driving integrated control system as set forth in any one of Appendices 1 to 14, wherein the abnormal state of the vehicle to be detected by the vehicle abnormal state detection unit of the autonomous driving device includes an abnormality of a tire air pressure sensor installed in the vehicle, and the travelable distance calculation unit of the autonomous driving device calculates the abnormal-time travelable distance according to a state of the abnormality of the tire air pressure sensor.

### (Appendix 16)

The autonomous driving integrated control system as set forth in any one of Appendices 1 to 15, wherein the selection unit of the autonomous driving device compares the respective intersection escape routes with each other after setting to zero the collision-avoidance level of the intersection escape route generated on a basis of information received from the roadside monitoring device that causes a delay in communication, to thereby select, per each of the abnormal-time travelable distances, the intersection escape route having a highest collision-avoidance level as the high-level intersection escape route.

### (Appendix 17)

The autonomous driving integrated control system as set forth in any one of Appendices 1 to 16, wherein, on the basis of the viewing angle information received from each of the roadside monitoring devices, the escape route generation unit generates each said intersection escape route so that it falls within a viewing field of the sensor.

### (Appendix 18)

The autonomous driving integrated control system as set forth in any one of Appendices 1 to 17, wherein the receiver unit, the escape route generation unit and the selection unit of the autonomous driving device are provided in an edge server that is connected through communication to the vehicle, and the vehicle abnormal state detection unit, the travelable distance calculation unit, the vehicle control unit and the vehicle operation unit are installed in the vehicle.

### (Appendix 19)

The autonomous driving integrated control system as set forth in any one of Appendices 1 to 17, wherein the receiver unit, the escape route generation unit, the selection unit, the travelable distance calculation unit and the vehicle control unit of the autonomous driving device are provided in an edge server that is connected through communication to the vehicle, and the vehicle abnormal state detection unit and the vehicle operation unit are installed in the vehicle.

What is claimed is:

1. An autonomous driving integrated control system, comprising multiple roadside monitoring devices and an autonomous driving device,
said multiple roadside monitoring devices each having:
a sensor that detects a nearby object; and
a transmitter that transmits viewing angle information of the sensor and information of the object detected by the sensor; and
said autonomous driving device having:
a receiver that receives the viewing angle information and the information of the object from the transmitter of each of the roadside monitoring devices;
a vehicle abnormal state detector that detects an abnormal state of a vehicle;
an escape route generator that generates, per each of the roadside monitoring devices and per each of multiple abnormal-time travelable distances, an intersection escape route for escaping from an intersection at an occurrence of abnormality in the vehicle entering the intersection, on a basis of the sets of information received from the roadside monitoring devices;
a selector that compares the respective intersection escape routes generated by the escape route generator, with each other in terms of their collision-avoidance levels each indicating a likelihood that the vehicle during travel on the intersection escape route will avoid a collision with the object, to thereby select, per each of the abnormal-time travelable distances, the intersection escape route having a highest collision-avoidance level as a high-level intersection escape route;
a travelable distance calculator that, when the abnormal state of the vehicle is detected by the vehicle abnormal state detector, calculates an abnormal-time travelable distance corresponding to one of said abnormal-time travelable distances and suited to the abnormal state;
a vehicle controller that, when the abnormal state of the vehicle entering the intersection is detected by the vehicle abnormal state detector, outputs a command signal for causing the vehicle to travel along, among the high-level intersection escape routes selected by the selector, the high-level intersection escape route corresponding to the abnormal-time travelable distance calculated by the travelable distance calculator; and
a vehicle operator that activates an actuator by using the command signal outputted by the vehicle controller.

2. The autonomous driving integrated control system of claim 1, wherein the selector of the autonomous driving device determines the collision-avoidance level to be “3” when no object is detected on the intersection escape route; to be “2” when a stationary object exists on the intersection escape route but will not cause a collision; to be “1” when a moving object exists on the intersection escape route but will not cause a collision; and to be “0” when an object exists on the intersection escape route and will cause a collision or its possibility of collision is unclear.

3. The autonomous driving integrated control system of claim 2, wherein, to the collision-avoidance level, the selector of the autonomous driving device adds “+3” when a stop point as an end point of the intersection escape route is placed in a station stopping lot, a stopping lane or a time-limited parking zone; adds “+2” when the stop point of the intersection escape route is placed in a roadside strip; and adds “+1” when the stop point of the intersection escape route is placed on a road shoulder.

4. The autonomous driving integrated control system of claim 1, wherein the autonomous driving device has multiple in-vehicle sensors that are installed in the vehicle and each detect a nearby object; and
wherein the travelable distance calculator of the autonomous driving device sets as the abnormal-time travelable distance, a predetermined first distance when one of the in-vehicle sensors temporarily causes a failure; a predetermined second distance that is shorter than the first distance, when one of the in-vehicle sensors continuously causes a failure; and a predetermined third distance that is shorter than the second distance, when more than one of the in-vehicle sensors continuously cause failures.

5. The autonomous driving integrated control system of claim 1, wherein the autonomous driving device has multiple in-vehicle sensors that are installed in the vehicle and each detect a nearby object, and a weather sensor that is installed in the vehicle and detects nearby weather conditions;
wherein the travelable distance calculator of the autonomous driving device sets as the abnormal-time travelable distance, a predetermined first distance when one of the in-vehicle sensors temporarily causes a failure; a predetermined fourth distance that is shorter than the first distance, when the weather sensor causes a failure; a predetermined second distance that is shorter than the fourth distance, when one of the in-vehicle sensors continuously causes a failure; a predetermined third distance that is shorter than the second distance, when more than one of the in-vehicle sensors continuously cause failures; and a predetermined fifth distance that is shorter than the third distance, when a drive mechanism or a brake mechanism of the vehicle causes a failure.

6. The autonomous driving integrated control system of claim 5, wherein the travelable distance calculator of the autonomous driving device sets to zero the fifth distance as the abnormal-time travelable distance.

7. The autonomous driving integrated control system of claim 1, wherein the autonomous driving device has multiple in-vehicle sensors that are installed in the vehicle and each detect a nearby object; and
wherein the vehicle controller of the autonomous driving device has:
a vehicle-side escape route generator that generates, with respect to a predetermined vehicle-side-escape-route generation distance, an intersection escape route for escaping from the intersection and then making a stop at an occurrence of abnormality in the vehicle entering the intersection, on a basis of the information received from the roadside monitoring devices and information detected by the in-vehicle sensors, to thereby set the thus-generated intersection escape route as a vehicle-side intersection escape route; and
a secondary selector that, when the abnormal state of the vehicle entering the intersection is detected by the vehicle abnormal state detector, selects the high-level intersection escape route corresponding to the abnormal-time travelable distance calculated by the travelable distance calculator when said abnormal-time travelable distance is longer than the vehicle-side-escape-route generation distance; and selects the vehicle-side intersection escape route generated by the vehicle-side escape route generator when the abnormal-time travelable distance calculated by the travelable distance calculator is equal to or less than the vehicle-side-escape-route generation distance; and
wherein the vehicle controller outputs the command signal or a command signal for causing the vehicle to travel along the high-level intersection escape route or the vehicle-side intersection escape route selected by the secondary selector.

8. The autonomous driving integrated control system of claim 4, wherein the vehicle controller of the autonomous driving device has:
a vehicle-side escape route generator that generates, with respect to the third distance, an intersection escape route for escaping from the intersection and then making a stop at an occurrence of abnormality in the vehicle entering the intersection, on a basis of the information received from the roadside monitoring devices and information detected by the in-vehicle sensors, to thereby set the thus-generated intersection escape route as a vehicle-side intersection escape route; and
a secondary selector that, when the abnormal state of the vehicle entering the intersection is detected by the vehicle abnormal state detector, selects the high-level inter-section escape route corresponding to the abnormal-time travelable distance calculated by the travelable distance calculator when said abnormal-time travelable distance is the first distance or the second distance; and selects the vehicle-side intersection escape route generated by the vehicle-side escape route generator when the abnormal-time travelable distance calculated by the travelable distance calculator is the third distance; and
wherein the vehicle controller outputs the command signal or a command signal for causing the vehicle to travel along the high-level intersection escape route or the vehicle-side intersection escape route selected by the secondary selector.

9. The autonomous driving integrated control system of claim 4, wherein the in-vehicle sensors of the autonomous driving device include at least one of a GNSS, a gyro sensor and a tire air pressure sensor.

10. The autonomous driving integrated control system of claim 1, wherein the abnormal state of the vehicle to be detected by the vehicle abnormal state detector of the autonomous driving device, includes a delay in communication, and the travelable distance calculator of the autonomous driving device calculates the abnormal-time travelable distance according to an amount of the delay in communication.

11. The autonomous driving integrated control system of claim 1, wherein the abnormal state of the vehicle to be detected by the vehicle abnormal state detector of the autonomous driving device, includes a positional abnormality of the vehicle, and the travelable distance calculator of the autonomous driving device calculates the abnormal-time travelable distance according to an amount of the positional abnormality of the vehicle.

12. The autonomous driving integrated control system of claim 1, wherein the abnormal state of the vehicle to be detected by the vehicle abnormal state detector of the autonomous driving device, includes a positioning abnormality of a GNSS installed in the vehicle, and the travelable distance calculator of the autonomous driving device calculates the abnormal-time travelable distance according to a state of the positioning abnormality of the GNSS.

13. The autonomous driving integrated control system of claim 1, wherein the abnormal state of the vehicle to be detected by the vehicle abnormal state detector of the autonomous driving device includes an abnormality of a gyro sensor installed in the vehicle, and the travelable distance calculator of the autonomous driving device calculates the abnormal-time travelable distance according to a state of the abnormality of the gyro sensor.

14. The autonomous driving integrated control system of claim 1, wherein the abnormal state of the vehicle to be detected by the vehicle abnormal state detector of the autonomous driving device, includes an abnormality of a weather sensor installed in the vehicle, and the travelable distance calculator of the autonomous driving device calculates the abnormal-time travelable distance according to a state of the abnormality of the weather sensor.

15. The autonomous driving integrated control system of claim 1, wherein the abnormal state of the vehicle to be detected by the vehicle abnormal state detector of the autonomous driving device includes an abnormality of a tire air pressure sensor installed in the vehicle, and the travelable distance calculator of the autonomous driving device calculates the abnormal-time travelable distance according to a state of the abnormality of the tire air pressure sensor.

16. The autonomous driving integrated control system of claim 1, wherein the selector of the autonomous driving device compares the respective intersection escape routes with each other after setting to zero the collision-avoidance level of the intersection escape route generated on a basis of information received from the roadside monitoring device that causes a delay in communication, to thereby select, per each of the abnormal-time travelable distances, the intersection escape route having a highest collision-avoidance level as the high-level intersection escape route.

17. The autonomous driving integrated control system of claim 1, wherein, on the basis of the viewing angle information received from each of the roadside monitoring devices, the escape route generator generates each said intersection escape route so that it falls within a viewing field of the sensor.

18. The autonomous driving integrated control system of claim 1, wherein the receiver, the escape route generator and the selector of the autonomous driving device are provided in an edge server that is connected through communication to the vehicle, and the vehicle abnormal state detector, the travelable distance calculator, the vehicle controller and the vehicle operator are installed in the vehicle.

19. The autonomous driving integrated control system of claim 1, wherein the receiver, the escape route generator, the selector, the travelable distance calculator and the vehicle controller of the autonomous driving device are provided in an edge server that is connected through communication to the vehicle, and the vehicle abnormal state detector and the vehicle operator are installed in the vehicle.
